(19) United States
(12) Patent Application Publication
(10) Pub. No.: US 2010/0285950 A1
(43) Pub. Date: Nov. 11, 2010

(54) CO-CATALYSTS FOR HYBRID CATALYSTS, HYBRID CATALYSTS COMPRISING SAME, MONOCOMPONENT CATALYSTS, METHODS OF MANUFACTURE AND USES THEREOF

(75) Inventor: Raymond Le Van Mao, Saint-Laurent (CA)

Correspondence Address: GOUDREAU GAGE DUBUC, 2000 MCGILL COLLEGE, SUITE 2200, MONTREAL, QC, H3A 3H3, CA

(73) Assignee: VALORBEC SOCIETE EN COMMANDITE

(21) Appl. No.: 12/665,447

(22) PCT Filed: Jun. 17, 2008
(86) PCT No.: PCT/CA08/01163

§ 371 Date: Jul. 6, 2010

Related U.S. Application Data
(60) Provisional application No. 60/944,617, filed on Jun. 18, 2007.
(60) Provisional application No. 60/944,623, filed on Jun. 18, 2007.

(51) Int. Cl. B01J 29/072; B01J 21/04; B01J 23/10

(52) U.S. Cl. 502/65; 502/335; 502/304; 502/327; 502/210; 502/229; 502/227; 502/211

(57) ABSTRACT

Co-catalysts comprising yttria-stabilized aluminum oxide having nickel oxide loaded thereon, their uses and methods of preparing are described. Also, hybrid catalysts comprising these co-catalysts along with main catalyst components, and their uses and methods of preparing are described. Monocomponent catalysts having nickel oxide loaded thereon, their uses and methods of preparing are also described.

### CROSS REFERENCE TO RELATED APPLICATIONS

N/A.

### FIELD OF THE INVENTION

The present invention relates to co-catalysts for hybrid catalysts, to hybrid catalysts comprising these co-catalysts and to monocomponent catalysts. The invention also relates to methods of manufacture and uses of these co-catalysts, hybrid catalysts and monocomponent catalysts. More specifically, the present invention relates to catalysts useful for thermocatalytic cracking of hydrocarbon feedstocks and for the catalytic conversion of steam-cracking liquid products and unsaturated liquid hydrocarbons.

### BACKGROUND OF THE INVENTION

Steam-cracking or pyrolysis of hydrocarbons is one of the core processes in the petrochemical industry. Current world production of steam-cracking products is estimated to more than 150 million metric tons/year of ethylene and propylene.

Basically, steam-cracking comprises a step in which the hydrocarbon mixture to be transformed is mixed with steam and submitted to elevated temperatures in a tubular reactor. The reaction temperature usually ranges from 800 to 1000° C. according to the type of feedstock treated (the longer the hydrocarbon molecular structure, the lower the required temperature for cracking) while the residence time ranges from a few seconds to a fraction of second. The resulting gaseous or liquid products are then collected and separated. Thus, the product distribution depends on the nature of the initial hydrocarbon mixture and the reaction conditions.

During steam-cracking, light paraffins (ethane, propane and butane, obtained mainly by extraction from various natural gas sources), hydrocarbons from naphthas, gas oils and other heavier petroleum cuts are broken down (cracked) into mainly:
(a) light olefins, primarily ethylene and propylene,
(b) secondarily, depending on the feedstock employed, a C₄ cut rich in butadienes and a C₅₊ cut with a high content of aromatics, particularly benzene, and
(c) hydrogen.

More specifically, steam-cracking of light paraffins (ethane, propane and butane) or liquid hydrocarbon feedstocks (naphtha, atmospheric or vacuum gas oil) produces pyrolysis gasolines and (pyrolysis) fuel oils. Pyrolysis gasolines that contain highly branched paraffins, naphthenes and aromatics, constitute good blending stocks for the gasoline pool because of their high research octane number. However, when directly collected from the steam-cracker (and subsequently separated), they also contain large quantities of diolefins and alkenylbenzenes that make them unsuitable as premium gasoline components because of the instability of such compounds at high temperatures. Thus, these gasolines have to undergo hydrotreating (selective catalytic hydrogenation: actually, two successive operations (hydrodedienization and hydrodesulfurization) prior to their addition to the gasoline pool, so that the diolefins and the alkenylbenzenes can be converted into olefins and alkylaromatics, respectively. In addition, alpha-olefins are converted into beta- or gamma-olefins, then eventually into paraffins. During the catalytic hydrotreating operation, diolefins, cyclodiolefins and alkenyl-aromatics may undergo polymerization, leading to some encrusting of the catalyst. Thus, in order to avoid such unwanted phenomenon, the reaction usually takes place at low temperature, in the liquid phase, and with rapid heat removal.

Ethylene and propylene are the most important “first generation” intermediates of the petrochemical industry, whose end-products include main plastics and synthetic fibers. The current technology of production of these olefins is steam cracking, using various hydrocarbon feedstocks (ethane, propane, naphthas, and gas oils). Market demands for ethylene and propylene recently have experienced significant and constant increases, showing, in particular, a higher growth rate for propylene. However, because the product selectivity of the steam cracking for propylene is quite low, the supply of this light olefin can be compensated through the use of other processes, such as propane dehydrogenation, olefin metathesis, and, primarily, fluidized bed catalytic cracking (FCC). The latter technology, whose main mandate is to produce gasoline, must incorporate some ZSM-5-type zeolite as a catalyst additive so that the production of light olefins, particularly propylene, can be increased significantly.

Almost twenty years ago, a method for upgrading products of propane steam-cracking was developed [R. Le Van Mao, U.S. Pat. No. 4,732,881 (22 March 1988); R. Le Van Mao, Microporous and Mesoporous Materials, 28 (1999), 9]. The process comprised adding a small catalytic reactor to a conventional propane steam-cracker. The catalysts used were based on hybrid zeolite catalysts, namely ZSM-5 zeolite modified with Al and Cr. Significant increases in the yield of ethylene and aromatics were obtained.

An improved process, called selective deep catalytic cracking, was subsequently developed [R. Le Van Mao, S. Melançon, C. Gauthier-Campbell and P. Kletnieks, Catalysis Letters 73 (2/4) (2001) 181; R. Le Van Mao, WO/2001/032806, Int. filing date: Mar. 11, 2000 and U.S. Pat. No. 7,135,602 (Nov. 14, 2006)]. The process used a tubular reactor with two heating zones set at the two ends of the reactor. The first heating zone (I) was empty or contained a robust solid material which acted primarily as a heat transfer medium. The second heating zone (II) was loaded with a ZSM-5 zeolite based catalyst, preferably of a hybrid configuration wherein at least two co-catalysts were commingled. Variations of the temperature of heating zone I versus heating zone II and the textural properties and/or the surface composition of the catalyst of zone (II) were used to increase conversion and to vary the product distribution, namely the ethylene/propylene ratio.

Subsequently, new catalysts which required a simpler 1-heating zone reactor were developed [R. Le Van Mao, U.S. Pat. No. 7,098,162 B2 (Aug. 26, 2006); S. Melançon, R. Le Van Mao, P. Klenieks, D. Ohayon, S. Intern, M. A. Saberi, and D. McCann, Catalysis Letters 80 (3/4), (2002), 103]. These monocomponent and hybrid catalyst compositions for use in the cracking of hydrocarbon feeds, comprised oxides of aluminum, silicon, chromium, and optionally, oxides of monovalent alkaline metals.

Additionally, improved catalysts were described [R. Le Van Mao, U.S. Pat. No. 7,026,263 B2 (Apr. 11, 2006).]. In both monocomponent and hybrid configurations, these comprised molybdenum or tungsten oxides, cerium oxide, lanthanum oxide.

Very recently, hybrid catalysts containing molybdenum or tungsten, cerium or lanthanum, phosphorus or chloride, palladium, tin, supported on silica-alumina, yttrium stabilized aluminum oxide or zirconium oxide were developed [N. Al-Yassir, R. Le Van Mao and F. Heng, Catalysis Letters, Vol 100, #1-2 (2005) 1; N. Al-Yassir and R. Le Van Mao, Applied Catalysis A: General, 305 (2006) 130; R. Le Van Mao, N. T. Vu, N. Al-Yassir, N. François and J. Monnier, Topics in Catalysis 37 (2-4), (2006), 107]. These catalysts are used in the thermocatalytic cracking (TCC) of gas oils or other hydrocarbon distillates.

The thermocatalytic cracking (TCC) process has for objective to selectively produce light olefins—particularly ethylene and propylene in quite equal proportions—from liquid hydrocarbon feedstocks such as petroleum naphthas and gas oils. The TCC process, which combines (mild) thermal cracking with the effect of a moderately acidic catalysts, can provide very high yields of ethylene and propylene (and other light olefins) while operating at a temperature much lower than those used for steam cracking [R. Le Van Mao, S. Melançon, C. Gauthier-Campbell, P. Kletniek, Catal. Lett., 107 (2001) 699; S. Melançon, R. Le Van Mao, P. Kletniek, D. Ohayon, S. Intern, M. A. Saberi, D. McCann, Catal. Lett., 80 (2002) 103.].

The present description refers to a number of documents, the content of which is herein incorporated by reference in their entirety.

### SUMMARY OF THE INVENTION

Co-Catalyst and Hybrid Catalysts

The present invention relates to co-catalysts comprising yttria-stabilized aluminum oxide having nickel oxide loaded thereon. The invention also relates to a method of preparing co-catalysts. This method comprises: (A) providing yttria-stabilized aluminum oxide; and (B) loading nickel oxide onto the yttria-stabilized aluminum oxide.

In specific embodiments of the invention, the co-catalysts may comprise between about 0.5 and about 6 wt % of nickel (in the form of nickel oxide) and more specifically between about 1 and about 4 wt % of nickel (in the form of nickel oxide).

In other specific embodiments, the co-catalysts may further comprise cerium oxide, rhenium oxide, ruthenium oxide, tin oxide or mixtures thereof. Also, the method may further comprise the step of loading cerium oxide, rhenium oxide, ruthenium oxide, tin oxide or mixtures thereof onto the yttria-stabilized aluminum oxide.

In more specific embodiments, the co-catalysts may comprise between about 0.5 and about 4 wt % of cerium oxide, up to about 1.5 wt % of rhenium oxide, up to about 0.5 wt % ruthenium oxide, or up to about 4.0 wt % tin oxide.

In specific embodiments of the invention, the yttria-stabilized aluminum oxide in the co-catalysts may comprise between about 5 and about 15 wt % of yttrium oxide.

The invention also relates to the use of the co-catalysts of the invention in the preparation of a hybrid catalyst as well as to hybrid catalysts comprising the co-catalyst of the invention and a main catalyst component. In more specific embodiments, the hybrid catalyst may comprise between about 10 and about 25 wt % of the co-catalyst.

In embodiments, the main catalyst component may comprise yttria-stabilized aluminium oxide having loaded thereon (A) molybdenum oxide, tungsten oxide or mixtures thereof; (B) cerium oxide, lanthanum oxide or mixture thereof; and (C) phosphorus, chloride or mixtures thereof. In more specific embodiments, the main catalyst component may comprise between about 70 and about 90 wt % of the yttria-stabilized aluminium oxide.

In embodiments, the main catalyst component may comprise yttria-stabilized aluminium oxide, yttria-stabilized zirconium oxide or mixtures thereof, the yttria-stabilized aluminium oxide, yttria-stabilized zirconium oxide or mixtures thereof having loaded thereon: (A) molybdenum oxide, tungsten oxide or mixtures thereof; (B) cerium oxide, lanthanum oxide or mixture thereof; and (C) phosphorus, sulfur, chloride or mixtures thereof. In more specific embodiments, the main catalyst component may comprise between about 70 and about 90 wt % of the yttria-stabilized aluminium oxide. In other specific embodiments, the main catalyst components may comprise between about 70 and about 90 wt % of the yttria-stabilized zirconium oxide. In other embodiments, this main catalyst component may comprise between about 0.5 and about 2 wt % of sulfur.

In embodiments, the main catalyst component may comprise an acidic ZSM-5 zeolite having loaded thereon: (A) molybdenum oxide, tungsten oxide or mixtures thereof; (B) yttrium oxide, cerium oxide, lanthanum oxide or mixtures thereof; and (C) phosphorus, chloride or mixtures thereof. In more specific embodiments, the main catalyst component may comprise between about 70 and about 90 wt % of the acidic ZSM-5 zeolite. In specific embodiment, this main catalyst component may comprise between about 0.5 and about 10 wt % of the yttrium oxide.

In more specific embodiments, all of the above-mentioned main catalyst components may comprise between about 3 and about 12 wt % of the molybdenum oxide. Alternatively, they may comprise between about 3 and about 12 wt % of the tungsten oxide. Also, in embodiments, they may comprise between about 0.5 and about 4 wt % of the cerium oxide. Alternatively, they may comprise between about 0.5 and about 4 wt % of the lanthanum oxide. In further embodiments, they may comprise between about 0.5 and about 5 wt % of the phosphorus. Alternatively, they may comprise between about 0.5 and about 5 wt % of the chloride.

In embodiments, the main catalyst component further may comprise nickel oxide loaded thereon. More specifically, the main catalyst component may comprise up to about 5 wt % of nickel (in the form of nickel oxide) and even more specifically, up to about 3 wt % of nickel (in the form of nickel oxide).

In embodiments, the hybrid catalyst may further comprise a binder. In more specific embodiments, it may comprise between about 10 and about 25 wt % of the binder. The binder may be bentonite clay.

The present invention also relates to a method of preparing a hybrid catalyst. This method comprises (A) providing a co-catalyst comprising nickel oxide loaded onto yttria-stabilized aluminum oxide; (B) providing a main catalyst component; and (C) mixing the co-catalyst with the main catalyst component to obtain a first mixture.

In embodiments, this method may further comprise (D) mixing the first mixture with a binder, thereby producing a final mixture; and (E) extruding the final mixture.

In more specific embodiments, the main catalyst component may be prepared by: (A) providing yttria-stabilized aluminium oxide; and (B) loading onto the yttria-stabilized aluminium oxide: (i) molybdenum oxide, tungsten oxide or mixtures thereof; (ii) cerium oxide, lanthanum oxide or mixture thereof; and (iii) phosphorus, chloride or mixtures thereof.

In other embodiments, the main catalyst component may be prepared by: (A) providing yttria-stabilized aluminium oxide, yttria-stabilized zirconium oxide or mixtures thereof, and (B) loading onto the yttria-stabilized aluminium oxide, yttria-stabilized zirconium oxide or mixtures thereof: (i) molybdenum oxide, tungsten oxide or mixtures thereof; (ii) cerium oxide, lanthanum oxide or mixture thereof; and (iii) phosphorus, sulfur, chloride or mixtures thereof.

In other embodiments, the main catalyst component may be prepared by: (A) providing an acidic ZSM-5 zeolite; and (B) loading onto the zeolite: (i) molybdenum oxide, tungsten oxide or mixtures thereof; (ii) yttrium oxide, cerium oxide, lanthanum oxide or mixtures thereof; and (iii) phosphorus, chloride or mixtures thereof.

Monocomponent Catalysts

The present invention also relates to a thermo-catalytic cracking monocomponent catalyst having nickel oxide loaded thereon.

In embodiments, the catalyst may comprise up to about 3 wt % of nickel (in the form of nickel oxide) and more specifically, between about 2.0 and about 2.5 wt % of nickel (in the form of nickel oxide). In embodiments, the catalyst may comprise up to about 2.4 wt % of nickel (in the form of nickel oxide).

The present invention also relates to a monocomponent catalyst comprising yttria-stabilized aluminum oxide having loaded thereon: (A) nickel oxide; (B) one of molybdenum oxide, tungsten oxide or mixtures thereof; (C) one of cerium oxide, lanthanum oxide or mixture thereof; and (D) one of phosphorus, chloride or mixtures thereof. In embodiments, the catalyst may comprise between about 75 and about 95 wt % of the yttria-stabilized aluminum oxide.

The present invention also relates to monocomponent catalyst comprising an acidic ZSM-5 zeolite having loaded thereon: (A) nickel oxide; (B) one of molybdenum oxide, tungsten oxide or mixtures thereof; (C) one of yttrium oxide, cerium oxide, lanthanum oxide or mixtures thereof; and (D) one of phosphorus, chloride or mixtures thereof. In embodiments, the catalyst may comprise between about 75 and about 95 wt % of the acidic ZSM-5 zeolite. In embodiments, the catalyst may comprise between about 0.5 and about 10 wt % of the yttrium oxide.

More specifically, the above mentioned catalysts may comprise up to about 3 wt % of nickel (in the form of nickel oxide), between about 2.0 and about 2.5 wt % of nickel (in the form of nickel oxide) or, in other embodiments comprise up to about 2.4 wt % of nickel (in the form of nickel oxide).

Also, in embodiments, the catalyst may comprise between about 3 and about 12 wt % of the molybdenum oxide. In other embodiments, it may comprise between about 3 and about 12 wt % of the tungsten oxide.

In further embodiments, the catalyst may comprise between about 0.5 and about 4 wt % of the cerium oxide. In other embodiments, it may comprise between about 2.0 and about 3.0 wt % of the lanthanum oxide.

Furthermore, in specific embodiments, the catalyst may comprise between about 0.5 and about 7 wt % of phosphorus. In other embodiments, it may comprise between about 0.5 and about 5 wt % of chloride.

In embodiments, the above mentioned catalysts may further comprise a binder. More specifically, they may comprise between about 10 and 25 wt % of the binder.

The present invention also relates to methods of preparing a catalyst.

In embodiments, the method comprises: (A) providing a thermo-catalytic cracking monocomponent catalyst; and (B) loading nickel oxide onto the catalyst, thereby producing a loaded catalyst.

In other embodiments, the method comprises: (A) providing yttria-stabilized aluminum oxide, and (B) loading onto the aluminum oxide (i) nickel oxide; (ii) one of molybdenum oxide, tungsten oxide or mixtures thereof; (iii) one of cerium oxide, lanthanum oxide or mixture thereof; and (iv) one of phosphorus, chloride or mixtures thereof, thereby producing a loaded catalyst.

In yet other embodiments, the method comprises: (A) providing an acidic ZSM-5 zeolite, and (B) loading onto the zeolite: (i) nickel oxide; (ii) one of molybdenum oxide, tungsten oxide or mixtures thereof; (iii) one of yttrium oxide, cerium oxide, lanthanum oxide or mixtures thereof; and (iv) one of phosphorus, chloride or mixtures thereof, thereby producing a loaded catalyst.

These methods may further comprise: (C) mixing the loaded catalyst with a binder, thereby producing a mixture, and (D) extruding the mixture.

Uses and Methods of Use of the Above (Hybrid and Monocomponent) Catalysts

The present invention also relates to the use of all of the above catalysts for thermo-catalytic cracking of a liquid hydrocarbon feedstock and for selectively producing light olefins during the thermo-catalytic cracking of a liquid hydrocarbon feedstock. The invention therefore also relates to (A) a method of thermo-catalytically cracking a liquid hydrocarbon feedstock, the method comprising putting any of the above catalysts in presence of the feedstock under thermo-catalytic cracking conditions, and (B) a method of selectively producing light olefins during the thermo-catalytic during the cracking of a liquid hydrocarbon feedstock, the method comprising putting any of the above catalysts in presence of the feedstock under thermo-catalytic cracking conditions.

In embodiments, the thermo-catalytic cracking is carried out at a temperature above about 700° C. In other embodiments, the thermo-catalytic cracking is carried out at a temperature below about 700° C. In specific embodiments, the thermo-catalytic cracking is carried out at a temperature between about 625° C. and about 675° C.

The present invention also relates to the use of any of the above catalysts for ring-opening of polyaromatic hydrocarbons. The invention therefore also relates to a method of ring-opening polyaromatic hydrocarbons, the method comprising putting any of the above catalysts in presence of the polyaromatic hydrocarbons under ring-opening conditions.

In embodiments, the polyaromatic hydrocarbons may be contained in of a liquid hydrocarbon feedstock.

In embodiments of all of the above uses and methods, the feedstock may be a gas oil or a petroleum naphtha. In specific embodiments, the gas oil may be atmospheric gas oil, heavy atmospheric gas oil or vacuum gas oil. In other embodiments, the petroleum naphtha may be light naphtha, medium-range naphtha or heavy naphtha.

The present invention also relates to the use of any of the above catalysts for catalytic conversion of a steam-cracking liquid product. Therefore, the present invention also relates to a method of catalytically converting a steam-cracking liquid product, the method comprising putting any of the above catalyst in presence of the steam-cracking liquid product under catalytic conversion conditions.

The present invention also relates to the use of any of the above catalysts for selectively producing light olefins during the catalytic conversion of a steam-cracking liquid product. Therefore, the present invention also relates to a method of selectively producing light olefins during the catalytic conversion of a steam-cracking liquid product, the method comprising putting any of the above catalysts in presence of the steam-cracking liquid product under catalytic conversion conditions.

In embodiments of these uses and method, steam-cracking liquid product is pyrolysis gasoline or a pyrolysis fuel oil. In specific embodiments, the pyrolysis gasoline is raw pyrolysis gasoline. In more specific embodiments, the pyrolysis gasoline is blended with petroleum naphtha.

The present invention also relates to the use of any of the above catalysts for catalytic conversion of a liquid unsaturated hydrocarbon. Therefore, the present invention also relates to a method of catalytically converting a liquid unsaturated hydrocarbon, the method comprising putting any of the above catalysts in presence of the liquid unsaturated hydrocarbon under catalytic conversion conditions.

The present invention also relates to the use of any of the above catalysts for selectively producing light olefins during the catalytic conversion of a liquid unsaturated hydrocarbon. Therefore, the present invention also relates to a method of selectively producing light olefins during the catalytic conversion of a liquid unsaturated hydrocarbon, the method comprising putting any of the above catalysts in presence of the liquid unsaturated hydrocarbon under catalytic conversion conditions.

In embodiments of these uses and method, the unsaturated hydrocarbon is an olefinic hydrocarbon, a diolefinic hydrocarbon, or a mixture thereof. In specific embodiments, the olefinic hydrocarbon is a long chain linear olefin. In more specific embodiments, the long chain linear olefin is an alpha olefin.

In more specific embodiments of all of the above uses and methods, the catalyst may be a hybrid catalyst as described above.

### DETAILED DESCRIPTION OF THE INVENTION

Co-Catalyst and Hybrid Catalysts

More specifically, in accordance with the present invention, there is provided new co-catalysts comprising nickel oxide loaded onto yttria-stabilized aluminum oxide, which may be used to produce hybrid catalysts.

The present inventor is the first to demonstrate that when such co-catalysts are used to prepare hybrid catalysts, they provide clear beneficial effects on the catalytic activity of these hybrid catalysts. One of these beneficial effects is that the presence of nickel oxide increases ring-opening of undesirable poly-aromatic hydrocarbons, which are coke precursors. This consequently leads to an increased yield in desirable light olefins.

Without being bound by theory, it is believed that the role of the nickel oxide containing co-catalyst is to produce “in situ” hydrogen species which are transferred to the main catalyst component, whose primary catalytic action is cracking, by a process known as spillover. It is believed that the beneficial effects of Ni on the catalytic activity of the catalysts of the present invention are due to this spillover process. The very active hydrogen species produced are indeed believed to have properties of hydrogenation and also ring-opening on poly-aromatic hydrocarbons at the level of acid sites where cracking occurs.

There is therefore provided co-catalysts comprising nickel oxide loaded onto yttria-stabilized aluminium oxide.

As used herein, “co-catalyst” refers to a catalyst component which is used with another catalyst component, called the main catalyst component, in a hybrid catalyst. A “catalyst component” is a solid material on which one or more substance may be loaded. A “hybrid catalyst” is a catalyst comprising a main catalyst component along with a co-catalyst. In such catalysts, the catalytic activity mainly resides in the main catalyst component and the co-catalyst has a secondary but usually beneficial role. For example, without being bound by theory, it is believed that the co-catalyst of the invention produces “in situ” hydrogen species which are transferred to the main catalyst component. In contrast, a “monocomponent catalyst” refers to a catalyst comprising only one catalyst component.

In specific embodiments, the yttria-stabilized aluminum oxide may comprise between about 5 and about 15 wt %, preferably between about 8 and about 12 wt %, of yttrium oxide.

In embodiments, the co-catalyst may further comprise cerium oxide, rhenium oxide, ruthenium oxide, tin oxide or mixture therefore loaded thereon. More specifically, the co-catalyst may comprise between about 0.5 and about 4 wt % cerium oxide, up to 1.5 about wt % rhenium oxide, up to about 0.5 wt % ruthenium oxide, or up to about 4 wt % tin oxide. More specifically, the co-catalyst may comprise between about 0.5 and about 3 wt % of tin oxide.

In specific embodiments, the co-catalyst component of the invention may comprise between about 94 and about 99.5 wt %, preferably between about 96 and about 98.5 wt %, of yttria-stabilized aluminum oxide and between about 0.5 and about 6 wt % (in the form of nickel oxide), preferably between about 1.5 and about 4 wt %, of nickel (in the form of nickel oxide). All the percentages are based on the total weight of the co-catalyst.

These co-catalysts may be used to produce different hybrid catalysts with poly-aromatic hydrocarbons ring-opening properties, particularly in the conversion of gas oils. These hybrid catalysts may be used in the thermo-catalytic cracking (TCC) of petroleum gas oils and other heavy hydrocarbon distillates.

The present invention also relates to hybrid catalysts comprising the above co-catalyst and a main catalyst component.

The main catalyst component may be a thermo-catalytic cracking main component. More specifically, it may be any main component catalyst or monocomponent catalyst known to be useful for the thermo-catalytic cracking of hydrocarbon feedstocks.

The hybrid catalyst may comprise between about 7 and about 25 wt %, preferably between about 10 and about 20 wt % of the co-catalyst, between about 60 and about 75 wt %, preferably between about 65 and about 70 wt % of the main catalyst component, between about 10 and about 25 wt %, preferably between about 15 and about 20 wt % of a binder, based on the total weight of the hybrid catalyst.

More specifically, the main component catalyst may be yttria-stabilized aluminium oxide, a first oxide selected from the group consisting of molybdenum oxide, tungsten oxide and mixtures thereof; a second oxide selected from the group consisting of cerium oxide, lanthanum oxide and mixture thereof; and an element selected from the group consisting of phosphorus, chloride or mixtures thereof, the first oxide, the second oxide and the element being loaded onto the yttria-stabilized aluminium oxide.

Alternatively, the main component catalyst may comprise an acidic ZSM-5 zeolite; a first oxide selected from the group consisting of molybdenum oxide, tungsten oxide and mixtures thereof; a second oxide selected from the group consisting of yttrium oxide, cerium oxide, lanthanum oxide and mixtures thereof; and an element selected from the group consisting of phosphorus, chloride or mixtures thereof, the first oxide, the second oxide and the element being loaded onto the acidic ZSM-5 zeolite.

In this catalyst, the acidic ZSM-5 zeolite is stabilized and/or promoted by Y, Ce or La. This acidic ZSM-5 zeolite, alone or loaded with different substances, is predominantly microporous.

Also, the main component catalyst may comprise a support selected from the group consisting of yttria-stabilized aluminium oxide, yttria-stabilized zirconium oxide or mixtures thereof, a first oxide selected from the group consisting of molybdenum oxide, tungsten oxide and mixtures thereof; a second oxide selected from the group consisting of cerium oxide, lanthanum oxide and mixture thereof; and an element selected from the group consisting of phosphorus, sulfur, chloride or mixtures thereof, the first oxide, the second oxide and the element being loaded onto the support.

More specifically, the main component may comprise:
between about 70 and about 90 wt % of yttria-stabilized aluminium oxide,
between about 70 and about 90 wt % of yttria-stabilized zirconium oxide,
between about 70 and about 90 wt % of acidic ZSM-5 zeolite,
between about 3 and about 12 wt % of molybdenum oxide,
between about 3 and about 12 wt % of tungsten oxide,
between about 0.5 and about 10 wt % of yttrium oxide,
between about 0.5 and about 4 wt % of cerium oxide,
between about 0.5 and about 4 wt % of lanthanum oxide,
between about 0.5 and about 5 wt % of phosphorus,
between about 0.5 and about 5 wt % of chloride, and/or
between about 0.5 and about 2 wt % of sulfur.
   All the percentages are based on the total weight of the main catalyst component.

The main catalyst components may also comprise nickel oxide. More specifically, they may comprise between about 0 to about 5 wt %, preferably between about 0 and 3 wt % of nickel (in the form of nickel oxide).

The catalysts may also comprise a binder. Typically, the catalyst and the binder are mixed together and then extruded. The binder used in the catalysts of the invention may be any binder known by the person of skill in the art to be useful in the preparation of catalysts. More specifically, the binder is a thermally stable inorganic material. The binder may be a clay, such as bentonite clay.

The present invention also provides methods of making hybrid catalysts.

Such a method comprises the steps of providing co-catalyst comprising nickel oxide loaded onto yttria-stabilized aluminum oxide; providing a main catalyst component, such as a thermo-catalytic cracking main catalyst component; and mixing the co-catalyst with the main catalyst component to obtain a first mixture.

This method may further comprise the step of mixing the first mixture with a binder, thereby producing a final mixture; and extruding the final mixture.

In embodiments, the main catalyst component may be prepared by providing yttria-stabilized aluminium oxide; and loading onto the yttria-stabilized aluminium oxide: (i) a first oxide selected from the group consisting of molybdenum oxide, tungsten oxide and mixtures thereof; (ii) a second oxide selected from the group consisting of cerium oxide, lanthanum oxide and mixture thereof; and (iii) an element selected from the group consisting of phosphorus, chloride or mixtures thereof.

In other embodiments, the main catalyst component may also be prepared by providing an acidic ZSM-5 zeolite; loading onto the acidic ZSM-5 zeolite: (i) a first oxide selected from the group consisting of molybdenum oxide, tungsten oxide and mixtures thereof; (ii) a second oxide selected from the group consisting of yttrium oxide, cerium oxide, lanthanum oxide and mixtures thereof; and (iii) an element selected from the group consisting of phosphorus, chloride or mixtures thereof.

In other embodiments, the main catalyst component may also be prepared by providing a support selected from the group consisting of yttria-stabilized aluminium oxide, yttria-stabilized zirconium oxide or mixtures thereof, and loading onto the support: (i) a first oxide selected from the group consisting of molybdenum oxide, tungsten oxide and mixtures thereof; (ii) a second oxide selected from the group consisting of cerium oxide, lanthanum oxide and mixture thereof; and (iii) an element selected from the group consisting of phosphorus, sulfur, chloride or mixtures thereof.

Monocomponent Catalysts

In accordance with the present invention, there is also provided new monocomponent catalysts comprising nickel oxide loaded thereon. The present inventor is the first to demonstrate that nickel oxide loaded onto monocomponent catalysts has clear beneficial effect on their catalytic activity. One of these beneficial effects is that the presence of nickel oxide increases ring-opening of poly-aromatic hydrocarbons, which are undesirable coke precursors. This consequently leads to an increased yield in desirable light olefins.

Without being bound by theory, it is believed that the role of the nickel oxide is to produce “in situ” hydrogen species which are transferred to the rest of the catalyst by a process known as spillover. It is believed that the clear beneficial effects of Ni on the catalytic activity of the catalysts of the present invention are due to this spillover process. The very active hydrogen species produced are indeed believed to have properties of hydrogenation and also ring-opening on poly-aromatic hydrocarbons at the level of acid sites where cracking occurs.

There is therefore provided monocomponent catalysts having nickel oxide loaded thereon.

As used herein, “monocomponent catalyst” refers to a catalyst comprising only one catalyst component. A catalyst component is a solid material on which one or more substance may be loaded or impregnated. A monocomponent catalyst therefore comprises only one such catalyst component, which is usually, but not necessarily, mixed with a binder. In contrast, hybrid catalysts are produced using at least two different catalyst components, which may then be mixed with a binder.

The catalyst on which nickel oxide is loaded may advantageously be a catalyst used for the thermo-catalytic cracking of hydrocarbon feedstock. In fact, any catalyst known by the person of skill in the art to be useful for the thermo-catalytic cracking of hydrocarbon feedstocks may be used. In this case, ring-opening of the polyaromatic hydrocarbons will occur approximately concurrently with the catalytic cracking.

As used herein “thermo-catalytic cracking monocomponent catalyst” refers to a monocomponent catalyst useful for the thermo-catalytic cracking of hydrocarbon feedstocks.

In a specific embodiment of the catalyst of the invention, the catalyst comprises yttria-stabilized aluminum oxide, nickel oxide, a first oxide selected from the group consisting of molybdenum oxide, tungsten oxide and mixtures thereof, a second oxide selected from the group consisting of cerium oxide, lanthanum oxide and mixture thereof and an element selected from the group consisting of phosphorus, chloride and mixtures thereof. In this catalyst, the nickel oxide, the first oxide, the second oxide and the element are loaded onto the yttria-stabilized aluminum oxide.

In specific embodiments, yttria-stabilized aluminum oxide may comprise between about 5 and about 25 wt %, preferably between about 8 and about 12 wt %, of yttrium oxide.

In another specific embodiment of the catalyst of the invention, the catalyst comprises an acidic ZSM-5 zeolite, nickel oxide, a first oxide selected from the group consisting of molybdenum oxide, tungsten oxide and mixtures thereof, a second oxide selected from the group consisting of yttrium oxide, cerium oxide, lanthanum oxide and mixtures thereof; and phosphorus, chloride or mixtures thereof. In this catalyst, the nickel oxide, first oxide, second oxide and phosphorus, chloride or mixtures thereof are loaded onto the zeolite.

In this catalyst, the acidic ZSM-5 zeolite is stabilized and/or promoted by Y, Ce or La.

The monocomponent catalysts may also comprise a binder. Typically, the catalyst and the binder are mixed together and then extruded. The binder used in the catalysts of the invention may be any binder known by the person of skill in the art to be useful in the preparation of catalysts. More specifically, the binder may be a thermally stable inorganic material. The binder may be a clay, such as bentonite clay.

In general, the above-mentioned catalysts may comprise:
between about 75 and about 95 wt % of yttria-stabilized aluminum oxide or acidic ZSM-5 zeolite,
between about 0.5 and about 10 wt % of yttrium oxide,
between about 3 and about 12 wt % of molybdenum oxide (MoO₃),
between about 3 and about 12 wt % of tungsten oxide (WO₃),
between about 2 and 3 wt % of lanthanum oxide (La₂O₃),
between about 0.5 and 4.0 wt % of cerium oxide (CeO₂),
between about 0.5 and about 7 wt % of phosphorus (P), and
between about 0.5 and about 5 wt % of chloride (Cl), and
between about 10 and about 25 wt %, and preferably between about 18 and 22 wt %, of a binder.
   All the percentages are based on the total weight of the catalyst.

In embodiments, the catalysts of the invention may comprise up to about 3.0 wt % of nickel (in the form of nickel oxide), and more specifically up to about 2.4 wt % of nickel (in the form of nickel oxide), based on the total weight of the catalyst with the exclusion the binder. In more specific embodiments, the catalyst comprises between about 2.0 and 2.5 wt % nickel (in the form of nickel oxide).

The present invention also provides methods of making monocomponent catalysts.

One such method comprises the steps of (A) providing a thermo-catalytic cracking monocomponent catalyst, and (B) loading nickel oxide on the catalyst.

Another such method comprises the steps of (A) providing yttria-stabilized aluminum oxide; and (B) loading nickel oxide, a first oxide selected from the group consisting of molybdenum oxide, tungsten oxide and mixtures thereof, a second oxide selected from the group consisting of cerium oxide, lanthanum oxide and mixture thereof and phosphorus, chloride or mixtures thereof on the yttria-stabilized aluminum oxide.

Yet, another such method comprises the steps of (A) providing an acidic ZSM-5 zeolite; and (B) loading nickel oxide, a first oxide selected from the group consisting of molybdenum oxide, tungsten oxide and mixtures thereof, a second oxide selected from the group consisting of yttrium oxide, cerium oxide, lanthanum oxide and mixtures thereof, and phosphorus, chloride or mixtures thereof onto the zeolite.

These methods may further comprise the step of mixing the loaded catalyst with a binder, thereby producing a solid mixture; and extruding the mixture produced.

Uses and Methods of Use of the Above (Hybrid and Monocomponent) Catalysts

The present invention also relates to uses and methods of uses of the above catalysts.

The present invention relates to the use of all of the above catalysts for thermo-catalytic cracking of a liquid hydrocarbon feedstock and for selectively producing light olefins during the thermo-catalytic cracking of a liquid hydrocarbon feedstock. The invention therefore also relates to (A) a method of thermo-catalytically cracking a liquid hydrocarbon feedstock, the method comprising putting any of the above catalysts in presence of the feedstock under thermo-catalytic cracking conditions, and (B) a method of selectively producing light olefins during the thermo-catalytic during the cracking of a liquid hydrocarbon feedstock, the method comprising putting any of the above catalysts in presence of the feedstock under thermo-catalytic cracking conditions.

As used herein, “light olefins” refers to an olefin comprising up to 6 carbon atoms. Examples of light olefins include, without being so limited, ethylene, propylene and butylenes. As used herein, “olefin” refers to an unsaturated hydrocarbon compound containing at least one carbon-to-carbon double bond.

As used herein, “liquid hydrocarbon feedstock” includes light paraffins, naphtha (such as light, medium-range and heavy naphthas), gas oils (such as atmospheric gas oils, heavy atmospheric gas oils, and vacuum gas oils) and other heavy petroleum cuts.

As used herein, “thermo-catalytic cracking conditions” refers to operating conditions, non-limiting examples of which being pressure and temperature, where the thermo-catalytic cracking of the feedstock to be treated will occur. Such conditions can readily be determined by the skilled technician.

In embodiments, the thermo-catalytic cracking is carried out at a temperature above about 700° C. In other embodiments, the thermo-catalytic cracking is carried out at a temperature below about 700° C. In more specific embodiments, the thermo-catalytic cracking is carried out at a temperature between about 625° C. and about 675° C.

The present invention also relates to the use of any of the above catalysts for ring-opening of polyaromatic hydrocarbons. The invention therefore also relates to a method of ring-opening polyaromatic hydrocarbons, the method comprising putting any of the above catalysts in presence of the polyaromatic hydrocarbons under ring-opening conditions.

As used herein, “ring-opening conditions” refers to operating conditions, non-limiting examples of which being pressure and temperature, where the ring-opening of the PAHs to be treated will occur. Such conditions can readily be determined by the skilled technician.

Polyaromatic hydrocarbons, also called PAHs, are chemical compounds that consist of at least three fused aromatic rings. These PAHs may be contained in the above-mentioned liquid hydrocarbon feedstocks.

In embodiments, the polyaromatic hydrocarbons may be contained in of a liquid hydrocarbon feedstock.

In embodiments of all of the above uses and methods, the feedstock may be a gas oil or a petroleum naphtha. In specific embodiments, the gas oil may be atmospheric gas oil, heavy atmospheric gas oil or vacuum gas oil. In other embodiments, the petroleum naphtha may be light naphtha, medium-range naphtha or heavy naphtha.

The present invention also relates to the use of any of the above catalysts for catalytic conversion of a steam-cracking liquid product. Therefore, the present invention also relates to a method of catalytically converting a steam-cracking liquid product, the method comprising putting any of the above catalyst in presence of the steam-cracking liquid product under catalytic conversion conditions.

The present invention also relates to the use of any of the above catalysts for selectively producing light olefins during the catalytic conversion of a steam-cracking liquid product. Therefore, the present invention also relates to a method of selectively producing light olefins during the catalytic conversion of a steam-cracking liquid product, the method comprising putting any of the above catalysts in presence of the steam-cracking liquid product under catalytic conversion conditions.

As used herein, “catalytic conversion conditions” refers to operating conditions, non-limiting examples of which being pressure and temperature, where the catalytic conversion of the steam-cracking liquid product to be treated will occur. Such conditions can readily be determined by the skilled technician.

As used herein, “steam-cracking liquid products” refers to liquid products obtained during regular steam-cracking of light paraffins (ethane, propane and butane) or liquid hydrocarbon feedstocks (naphtha, atmospheric or vacuum gas oil). These products include pyrolysis gasolines and (pyrolysis) fuel oils. Pyrolysis gasolines generally contain highly branched paraffins, naphthenes and aromatics and, when they are directly collected from the steam-cracker (and subsequently separated), they also contain large quantities of diolefins and alkenylbenzenes.

In embodiments of these uses and method, the steam-cracking liquid product is a pyrolysis gasoline or a pyrolysis fuel oil. In specific embodiments, the pyrolysis gasoline is raw pyrolysis gasoline. In more specific embodiments, the pyrolysis gasoline is blended with petroleum naphtha.

The present invention also relates to the use of any of the above catalysts for catalytic conversion of a liquid unsaturated hydrocarbon. Therefore, the present invention also relates to a method of catalytically converting a liquid unsaturated hydrocarbon, the method comprising putting any of the above catalysts in presence of the liquid unsaturated hydrocarbon under catalytic conversion conditions.

The present invention also relates to the use of any of the above catalysts for selectively producing light olefins during the catalytic conversion of a liquid unsaturated hydrocarbon. Therefore, the present invention also relates to a method of selectively producing light olefins during the catalytic conversion of a liquid unsaturated hydrocarbon, the method comprising putting any of the above catalysts in presence of the liquid unsaturated hydrocarbon under catalytic conversion conditions.

As used herein, “liquid unsaturated hydrocarbon” refers to a liquid unsaturated compound that comprises at least one carbon-to-carbon double bond. Such liquid unsaturated hydrocarbons are available in some refineries. These compounds may be linear or branched. These products include olefinic and diolefinic hydrocarbons. As used herein, an olefinic hydrocarbon is an olefin comprising one carbon-to-carbon double bond. Similarly, a diolefinic hydrocarbon is an olefin comprising two carbon-to-carbon double bonds.

In embodiments of these uses and methods, the unsaturated hydrocarbon is an olefinic hydrocarbon, a diolefinic hydrocarbon, or a mixture thereof. In specific embodiments, the olefinic hydrocarbon is a long chain linear olefin. In more specific embodiments, the long chain linear olefin is an alpha olefin.

As used herein, alpha-olefins (or α-olefins) are a family of organic compounds which are olefins or alkenes with a chemical formula CₓH₂ₓ, distinguished by having a double bond at the primary or alpha (α) position (i.e. between the first and the second carbon atom).

In more specific embodiments of all of the above uses and methods, the catalyst may be a hybrid catalyst as described above.

As used herein, “acidic ZSM-5 zeolite” refers to a ZSM-5 zeolite with a SiO₂/Al₂O₃ molar ratio of at least about 25. In embodiments, the zeolite may have a SiO₂/Al₂O₃ molar ratio of about 50.

As used herein, “loaded”, as in “a substance loaded on a support”, refers to a substance which is impregnated, intimately deposited or adsorbed onto a (generally porous) support or is otherwise physically supported or carried by it. Such loading may be performed by exposing the support to a solution of the substance and then removing the solvent (by evaporation or other means), leaving the substance loaded on the support. The substance is not merely mixed with the porous support; it is not necessarily chemically linked with it either.

As used herein, “yttria-stabilized aluminum oxide” refers to a mixture of aluminum oxide and yttrium oxide produced by the sol-gel technique. This treatment is effected using an aluminum alkoxide and a source of yttrium. This treatment has the effect of including yttrium oxide in the aluminium oxide, thereby stabilizing it. Non limiting examples of suitable aluminum alkoxides are Al s-butoxide, Al tert-butoxide, Al isopropoxide and Al tri-sec-butoxide. Non limiting examples of suitable sources of yttrium are Y(III) nitrate hexahydrate, acetylacetonate hydrate, and Y(III) acetate hydrate. Yttria-stabilized aluminum oxide, alone or impregnated with different substances, is mesoporous.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is the on-stream behavior of hybrid catalyst HYB-1(1) and reference catalyst REF-1 [Y_{E+P}=combined product yield of ethylene and propylene, and Y_{UC2-C4}=yield of C₂-C₄ unsaturated products (empty symbols denote HYB-1 and full symbols denote REF-1) versus the time-on-stream (tₒₛ, given in hours), respectively. Reaction conditions: temperature, 740° C.; mass of catalyst (W), 5 g; weight hourly space velocity (WHSV) (in reference to feed), 2.0 h⁻¹; feed, light naphtha (L-N); and steam/feed weight ratio, 0.9. Observed product propylene/ethylene ratio=0.86.];

FIG. 2 is the assumed intervention level (IL) of the hydrogen spilt-over species (being produced in situ on the co-catalyst surface) on the reaction intermediates at the cracking sites;

FIG. 3 is the FT-IR spectra of adsorbed pyridine of the main components (MCC-1 (spectrum C) and MCC-2 (spectrum D)) and their corresponding “active” supports (AAS (spectrum A) and ZSM-5 zeolite (spectrum B)); and

FIG. 4 is the acid strength profile obtained using the NH₃-TPD/ISE method: (A) H-ZSM5, (B) MCC-2, and (C) MCC-1. (Δ)=d[NH₄]/dt (given in units of mmol g⁻¹ ° C⁻¹).

### DESCRIPTION OF ILLUSTRATIVE EMBODIMENTS

The present invention is illustrated in further details by the following non-limiting examples.

### Example 1

### Preparation of Different Co-Catalysts, Main Catalyst Components and Hybrid Catalysts

Yttria-stabilized aluminum oxide as well as different co-catalysts and different main catalyst components were prepared. These are listed in Table 1.

TABLE 1
Yttria-stabilized Aluminum Oxide (Y—Al),
Co-catalysts and Main Catalyst Components

| Catalyst component | Description |
|---|---|
| Y—Al | Alumina + Y₂O₃ |
| Main catalyst components | |
| Y—Al (Mo, Ce, P) | Y—Al + MoO₃ + CeO₂ + P |
| Zeolite (Y, Mo, P) | Acidic ZSM-5 zeolite + Y₂O₃ + MoO₃ + P |
| Co-catalysts | |
| Y—Al (Ni 1.9%) | Y—Al + 2.4% NiO (i.e. 1.9% Ni) |
| Y—Al (Ni 2.8%) | Y—Al + 3.5% NiO (i.e. 2.8% Ni) |
| Y—Al (Ni 3.8%) | Y—Al + 4.7% NiO (i.e. 3.8% Ni) |
| Y—Al (Ni, Re) | Y—Al + NiO + ReO₂ |
| Y—Al (Ni, Ce) | Y—Al + NiO + CeO₂ |

Y—Al. Yttria-stabilized aluminum oxide (alumina) (herein referred to as Y—Al) was prepared by the sol-gel technique. It is a thermally and hydrothermally stable support.

Solution A was prepared by dissolving 450.0 g of Al s-butoxide (Strem Chemicals) in 300 ml of 2-butanol. Solution B was obtained by dissolving 42.5 g of Y(III) nitrate hexahydrate (Strem) in 100 ml of methanol (Aldrich). Solution B was added—under vigorous stirring, always at room temperature—into solution A. When the slurry was apparently homogeneous, 80 ml of water were rapidly added. The hydrolysis reaction immediately started resulting in a noticeable heat release. The slurry became stirrable after a few minutes. This slurry was then left under moderate stirring at room temperature for 4 hours. The evaporation to almost dryness was carried out with very moderate heating for several days. The (still wet) solid was put in an oven at 285° C. After 2 hours at 285° C., the oven was heated at 750° C. for 5 hours.

The mesoporous resulting solid showed the following characteristics: Y₂O₃=ca. 10 wt % based on the total weight of the solid, BET surface area=290 m²g⁻¹.

### Main Catalyst Components:

Y—Al (Mo, Ce, P). A main catalyst component comprising Y—Al, Mo, Ce, and P [herein referred to as Y—Al (Mo, Ce, P)] was prepared

The solution obtained by dissolving 12.08 g of ammonium molybdate tetrahydrate (Strem) in 250 ml of H₃PO₄ 2N, was rapidly added (under thorough stirring) to 100.0 g of Y—Al. This slurry was left at room temperature (no stirring) for 30 minutes and then dried at 120° C. for 2 hours. Then a solution of 2.68 g of Ce (III) nitrate hexahydrate (Strem) in 50 ml of distilled water was added to the solid under moderate stirring. After 15 minutes left at room temperature, the solid was dried in an oven at 120° C. overnight and then activated at 500° C. for 3 hours.

The resulting solid showed concentrations in MoO₃, CeO₂ and P of ca. 8.6 wt %, ca. 0.9 wt %, and ca. 4.4 wt % based on the total weight of the solid respectively.

Zeolite (Y, Mo, P). A main catalyst component comprising yttrium, molybdenum and phosphorus loaded on a zeolite [herein referred to as Zeolite (Y, Mo, P)] was prepared

46.70 g of ZSM-5 zeolite (acidic form, 50 H,

$$( \frac{{SiO}_{2}}{{Al}_{2} {O}_{3}} molar ratio = ca .50 )$$

purchased from Zeochem, Switzerland) were impregnated with a solution obtained by dissolving 5.10 g of Y (III) nitrate hexahydrate (Strem) in 50 ml of distilled water. After drying at 120° C. overnight, the solid was activated at 740° C. for 3 hours. The solution prepared by dissolving 6.12 g of ammonium molybdate (Strem Chemicals) in 84 ml of H₃PO₄ 3N was rapidly added (under thorough stirring) to the previously obtained solid. After drying at 120° C. overnight and subsequent activation at 500° C. for 3 hours, the resulting solid showed the following concentrations: MoO₃=8.9 wt %, Y=2.1 wt %; P=4.7 wt %.

### Co-Catalysts:

Y—Al (Ni 1.9%), Y—Al (Ni 2.8%) and Y—Al (Ni 3.8%). Three nickel co-catalysts comprising Y—Al having loaded thereon nickel oxide [herein referred to as Y—Al (Ni n %, with n=1.9, 2.8, and 3.8, respectively)] were prepared.

5.00 g of Y—Al were impregnated with a solution obtained by dissolving X g of Ni (II) nitrate hexahydrate (Strem) in 15 ml of distilled water. After 15 minutes left at room temperature, the solid was dried in an oven at 120° C. overnight and then activated at 500° C. for 3 hours.

Three catalysts components were prepared with different Ni loading according to the amount of nickel nitrate (X) used. The following table shows the concentrations of Ni obtained (in the form of nickel oxide) corresponding to each amount of nickel nitrate used.

TABLE 2
Concentrations of Ni Obtained for Each Amount of Nickel
Nitrate Used.

| Amount of nickel nitrate used | Concentrations of Ni obtained |
|---|---|
| (g) | (wt %)* |
| 0.46 | 1.9 |
| 0.70 | 2.8 |
| 0.93 | 3.8 |

*Percentages based on the total weight of the co-catalyst

Y—Al (Ni, Re). A co-catalyst comprising Y—Al having loaded thereon nickel oxide and rhenium oxide [herein referred to as Y—Al (Ni, Re)] was prepared

5.00 g of Y—Al were impregnated with a solution obtained by dissolving 0.83 g of Ni nitrate hexahydrate (Strem) and 0.11 g of ReCl₃ (Strem) dissolved in 15 ml of distilled water. After drying at 120° C. overnight, the solid was activated at 500° C. for 3 hours.

The resulting solid contained ca. 3.4 wt % of Ni and ca. 1.4 wt % of Re (in the form of rhenium oxide) based on the total weight of the catalyst component.

Y—Al (Ni, Ce). A co-catalyst comprising Y—Al having loaded thereon nickel oxide and cerium oxide [herein referred to as Y—Al (Ni, Ce)] was prepared

The solution obtained by dissolving 7.8 g of Ni (II) nitrate hexahydrate (Strem) and 2.5 Ce (III) nitrate hexahydrate in 120 ml of water, was impregnated onto 50.0 g of Y—Al. After drying at 120° C. overnight, the solid was activated at 500° C. for 3 hours.

The resulting solid contained ca. 3.2 wt % of Ni (in the form of NiO) and ca. 2.0 wt % of CeO₂ based on the total weight of the catalyst component.

### Hybrid Catalysts

Different hybrid catalysts were prepared by mixing the co-catalysts with the main catalyst components of Example 1. These hybrid catalysts and their composition are described in the following table:

TABLE 3
Hybrid Catalysts and Their Content (Excluding the Binder)

| | | Main Catalyst |
|---|---|---|
| Hybrid catalyst | Co-catalyst | Component |
| HYB-01 | Y—Al (Ni 1.9%) | Y—Al (Mo, Ce, P) |
| HYB-02 | Y—Al (Ni 2.8%) | Y—Al (Mo, Ce, P) |
| HYB-03 | Y—Al (Ni 3.8%) | Y—Al (Mo, Ce, P) |
| HYB-04 | Y—Al (Ni, Re) | Y—Al (Mo, Ce, P) |
| HYB-05 | Y—Al (Ni, Ce) | Y—Al (Mo, Ce, P) |
| HYB-06 | Y—Al (Ni 2.8%) | Zeolite (Y, Mo, P) |

Catalysts HYB-01 through HYB-05. Catalysts HYB-01 through HYB-05 were prepared by thoroughly mixing 30.6 g of Y—Al (Mo, Ce, P) and 5.4 g of Y—Al (Ni 1.9%), Y—Al (Ni 2.8%), Y—Al (Ni 3.8%), Y—Al (Ni, Re), or Y—Al (Ni, Ce), respectively. 8.0 g of bentonite (Aldrich) were added to the solid mixture obtained. The resulting mixture was extruded with water. After drying at 120° C. overnight, the catalyst extrudates were finally activated at 740° C. for 3 hours.

Catalyst HYB-06. 8.00 g of Y-Zeolite (Mo, P) and 1.90 g of Y—Al (Ni 2.8%) were thoroughly mixed. To this solid mixture, 2.10 g of bentonite (Aldrich) were added for extrusion with water. After drying at 120° C. overnight, the catalyst extrudates were finally activated at 740° C. for 3 hours.

### Comparative Example 1

### Reference Catalysts

The catalyst components Y—Al (Mo, Ce, P) and Y-Zeolite (Mo, P) were extruded with bentonite clay (Aldrich, 18 wt % based on the total weight of the extruded catalyst). The resulting extrudates were dried at 120° C. overnight, and finally activated at 740° C. for 3 hours. These catalysts and their component are described in the following table

TABLE 4
Reference Catalysts

| Monocomponent | Content |
|---|---|
| Catalyst | (excluding the binder) |
| REF-01 | Y—Al (Mo, Ce, P) |
| REF-02 | Y-Zeolite (Mo, P) |

### Example 2

### Catalyst Testing

The catalysts of the Example 1 and Comparative Example 1 have been tested for their performances. The experiments were performed using a Lindberg tubular furnace with three heating zones. The experimental set-up and the testing procedure were similar to those reported elsewhere [R. Le Van Mao, N. T. Vu, N. Al-Yassir, N. François and J. Monnier, Topics in Catalysis 37 (2-4), (2006), 107]. Liquids, namely gas oil or light naphtha and water, were injected into a vaporizer using two infusion pumps. Nitrogen was used as carrier gas. The gaseous stream was then injected into the tubular reactor (quartz tube of 140 cm in length, 1.5 cm O.D. and 1.2 cm I.D.).

In the first series of tests (testing conditions A), the feed used was an atmospheric gas oil having the following properties: boiling points=175-400° C. and density=0.860 g cm⁻³. The other testing conditions were as follows:
weight of catalyst: 7.0 g;
weight hourly space velocity (WHSV, i.e. weight of gas oil and water injected per hour per weight of catalyst): 1.72 h⁻¹;
steam/gas oil weight ratio: 1.0;
nitrogen flow-rate: 3.0 cm³.min⁻¹; and
temperature: 725° C.

In a second series of tests (testing conditions B), the feed used was light naphtha having the following properties: boiling points=C₅-100° C. and density=0.650 g cm⁻³. The other testing conditions were as follows:
weight of catalyst=5.0 g;
weight hourly space velocity (WHSV, i.e. weight of light naphtha and water injected per hour per weight of catalyst)=4.2 h⁻¹;
steam/light naphtha weight ratio=0.5;
nitrogen flow-rate=3.0 cm³.min⁻¹; and
temperature=730° C.

Product liquid and gaseous fractions were collected separately and analyzed by gas chromatography. The yield of product (i) was expressed in grams of product recovered by 100 g of gas oil (or naphtha) injected (wt %). Experimental errors were less than 1 wt %.

Catalytic data obtained with reference catalyst (REF-01) and hybrid catalysts HYB-01 to HYB-05, which have the same main catalyst component [Y—Al (Mo, Ce, P)], but comprise a different co-catalyst, are reported in Table 5.

TABLE 5
Performances of Reference Catalyst REF-01 and Hybrid
Catalysts HYB-01 to HYB-05 (Testing Conditions A, Gas Oil Feed)

| | Catalyst | | | | | |
|---|---|---|---|---|---|---|
| | REF-01 | HYB-01 | HYB-02 | HYB-03 | HYB-04 | HYB-05 |
| % wt Ni in Ni- | 0 | 1.9 | 2.8 | 3.8 | 3.4 + Re | 3.2 + Ce |
| containing catalyst | | | | | | |
| component | | | | | | |

Product distribution (wt %)

| | | | | | | |
|---|---|---|---|---|---|---|
| C₂═ | 21.7 | 22.4 | 23.0 | 22.8 | 22.2 | 22.8 |
| C₃═ | 17.3 | 18.3 | 17.7 | 18.2 | 19.4 | 19.7 |
| C₄═ | 6.4 | 6.4 | 6.1 | 6.9 | 7.2 | 7.4 |
| Butadiene | 3.6 | 4.2 | 4.3 | 4.3 | 4.4 | 4.4 |
| BTX aromatics | 14.1 | 13.5 | 13.3 | 11.3 | 11.2 | 11.5 |
| 200-400° C. | 9.5 | 7.4 | 7.8 | 7.8 | 6.6 | 6.1 |
| Heavy hyd. | 0.0 | 0.0 | 0.0 | 0.0 | 0.0 | 0.0 |
| (>400° C.) | | | | | | |
| Methane | 11.5 | 12.0 | 11.1 | 11.8 | 12.5 | 12.1 |
| Hydrogen | 1.46 | 1.53 | 1.53 | 1.55 | 1.57 | 1.60 |
| Ethylene + | 39.0 | 40.7 | 40.7 | 41.0 | 41.6 | 42.5 |
| propylene | | | | | | |
| Propylene/ethylene | 0.80 | 0.82 | 0.78 | 0.80 | 0.87 | 0.86 |
| ratio | | | | | | |
| C₂═ + C₃═ + | 49.0 | 51.3 | 51.1 | 52.2 | 53.2 | 54.3 |
| C₄═ + butadiene | | | | | | |

It is clear from Table 5 that Ni exerted clear beneficial effects on the catalytic activity. In fact, the Ni-containing hybrid catalysts (HYB-01, HYB-02 and HYB-03) showed higher yields for light olefins and unsaturated gaseous hydrocarbons while the production of heavy liquid (polyaromatic) hydrocarbons (boiling point range=200-400° C.) significantly decreased.

The hydrogen production for these catalysts increased noticeably meaning that the hydrogen species “in situ” formed were extremely more active than the molecular hydrogen produced by the (thermal and catalytic) cracking reactions. Thus, with the decrease of the production of the heavy liquid fraction, the product spectrum was beneficially shifted towards the lighter unsaturated products (light olefins, particularly ethylene and propylene).

The use of bi-metallic oxides (Ni and Re for HYB-04 and Ni and Ce for HYB-05) enhanced the steam reforming properties of the catalysts. More hydrogen spilt-over species led to a lower formation of heavy liquid products and thus, a higher formation of light olefins. Interestingly, the propylene/ethylene weight ratio increased significantly.

Even more interestingly, while the conversion into light olefins (ethylene and propylene) of the reference catalyst decreased with time after having reached the steady state, the activity of the hybrid catalysts, such as HYB-06 and HYB-05, was stable for several days.

All this indicates a more efficient action of the Ni-containing catalyst component in terms of production and transfer of hydrogen spilt-over species, which resulted in enhanced hydrogenation of these heavy liquid products and enhanced ring-opening action on the (condensed) poly-aromatic hydrocarbons (PAH) at the level of the acid sites. In fact, these heavy liquid products are usually assumed to contain a large proportion of PAH which normally are the precursors of coke (carbonaceous deposit which causes catalyst activity decay). Thus, the reduction of coke formation on the main catalyst increased the catalyst on-stream stability which was effectively observed with the present hybrid catalysts.

Catalytic data obtained with hybrid catalysts HYB-02 and HYB-06 and reference catalyst REF-02 are reported in Table 6.

TABLE 6
Performance of Hybrid Catalysts HYB-02 and Reference
Catalyst REF-02 (Testing Conditions B), and HYB-06 (Testing
conditions A and B).

| Catalyst | | | | | | | |
|---|---|---|---|---|---|---|---|
| REF-02 | | | HYB-02 | HYB-06 | | | HYB-06* |
| Duration of test (h) | | | | | | | |
| 24 | 48 | 72 | 72 | 24 | 48 | 72 | 48 |

Product distribution (wt %)

| | | | | | | | | |
|---|---|---|---|---|---|---|---|---|
| C₂═ | 23.6 | 22.4 | 22.1 | 19.4 | 23.6 | 21.5 | 21.1 | 21.8 |
| C₃═ | 26.4 | 24.0 | 21.3 | 18.3 | 27.1 | 27.1 | 26.5 | 21.2 |
| C₄═ | 9.0 | 9.3 | 10.4 | 11.9 | 8.7 | 9.5 | 8.7 | 8.1 |
| Butadiene | 4.8 | 5.4 | 6.2 | 4.0 | 4.6 | 5.1 | 5.7 | 3.8 |
| BTX aromatics | 7.7 | 7.5 | 6.2 | 6.6 | 7.3 | 5.7 | 5.9 | 12.4 |
| 200-400° C. | 0.1 | 0.2 | 0.1 | 0.3 | 0.1 | 0.0 | 0.1 | 11.4 |
| Heavy hyd. (>400° C.) | 0.0 | 0.0 | 0.0 | 0.0 | 0.0 | 0.0 | 0.0 | 0.0 |
| Methane | 9.3 | 10.0 | 10.1 | 9.1 | 8.7 | 8.3 | 8.2 | 8.8 |
| Hydrogen | 1.8 | 1.8 | 1.7 | 1.6 | 1.8 | 1.8 | 1.8 | 1.55 |
| Ethylene + propylene | 50.0 | 46.4 | 43.4 | 37.7 | 50.7 | 48.6 | 47.6 | 43.0 |
| Propylene/ethylene | 1.1 | 1.1 | 1.0 | 0.9 | 1.2 | 1.3 | 1.3 | 0.97 |
| C₂═ + C₃═ + | 54.8 | 61.1 | 60.0 | 53.6 | 63.9 | 63.2 | 62.0 | 54.9 |
| C₄═ + butadiene | | | | | | | | |

*Testing conditions: A, gas oil feed

The hybrid catalyst of the invention (HYB-06) exhibited much higher on-stream stability than the corresponding reference catalyst (REF-02). In fact, after 72 hours of continuous operation, HYB-06 lost only 6.1% of its combined yield in ethylene and propylene, while the reference catalyst, REF-02 lost up to 13.2% during the same period of time.

It is worth mentioning that in an industrial process such as the TCC, a higher on-stream stability results in a longer “run length” (period of time separating two catalyst decoking operations), thus in a higher production efficiency and a lower total amount of greenhouse gases (carbon oxides) emitted during the same time of production.

It is also worth noting that HYB-06, when run in testing conditions A (feed: gas oil) gave a combined yield in ethylene+propylene significantly higher than that of HYB-02 (Table 5), i.e. 43.0 wt % against 40.7 wt %. In addition, the product propylene/ethylene ratio was much higher (1.0 against 0.8 for the HYB-02). Therefore, the use of hybrid catalysts containing (stabilized) ZSM-5 zeolite leads to a “propylene-plus” TCC process.

### Example 3

### Effect of the Split-Over Hydrogen Species on the Product Yields of the Hybrid Catalysts Used in the Thermocatalytic Cracking (TCC) Process for the Production of Light Olefins

### Catalyst Preparation

Preparation of the Yttria-Stabilized Aluminum Oxide Support (AAS). The yttria-stabilized aluminum oxide was prepared using a (sol-gel) procedure that was similar to that reported by Le Van Mao et al. [Le Van Mao, R.; Vu, N. T.; Al-Yassir, N.; François, N.; Monnier, J. Top. Catal. 2006, 37, 107] After the solid material has been activated at 750° C. for 3 h, it shows the following (approximate) chemical composition: 10 wt % Y₂O₃, with the balance being Al₂O₃.

### Preparation of the Main Catalyst Components (MCC)

MCC-1. A solution of 4.81 g of ammonium molybdate hexahydrate (Aldrich) in 100 mL of 1.8 N H₃PO₄ was homogeneously impregnated onto 40.02 g of yttria-stabilized aluminum oxide support (AAS). After drying at 120° C. overnight, the resulting solid was impregnated with a solution that was composed of 1.04 g of cerium(III) nitrate (Aldrich) in 30 mL of deionized water. The solid (MCC-1) was first dried at 120° C. overnight and activated in air at 500° C. for 3 h. Its chemical composition was as follows: MoO₃, 7.8 wt %; CeO₂, 0.8 wt %; phosphorus, 3.7 wt %; and Al₂O₃, balance.

MCC-2. A solution that was composed of 1.79 g of lanthanum nitrate hydrate (Strem Chemicals) in 50 mL of deionized water was homogeneously impregnated onto 20.00 g of ZSM-5 zeolite/25 H (powder, acid form, silica/alumina molar ratio) 34, purchased from Zeochem), which had been previously dried at 120° C. overnight. After being left at room temperature for 1 h and dried at 120° C. overnight, the solid was activated in air at 500° C. for 3 h. The solid was then homogeneously impregnated with a solution of 2.73 g of ammonium molybdate hexahydrate (Aldrich) in 36 mL of 3 N H₃PO₄ and 15 mL of deionized water. The solid was dried at 120° C. overnight and activated at 500° C. for 3 h. Its chemical composition was as follows: MoO₃, 8.3 wt %; La₂O₃, 3.7 wt %; phosphorus, 4.2 wt %; and zeolite, balance.

### Preparation of the Co-Catalysts (CO-CAT)

Co-Cat 1(n). Nickel-loaded co-catalysts were prepared as follows. A solution of X g of nickel nitrate hexahydrate (Strem) in 15 mL of deionized water was homogeneously impregnated onto 5.00 g of AAS. After drying at 120° C. overnight, the solid was activated in air at 500° C. for 3 h. The resulting solids were called Co-Cat 1(1), Co-Cat 1(2), and Co-Cat 1(3) when X=0.42, 0.70, and 0.83, respectively. The nickel contents of these co-catalysts were 1.7, 2.8, and 3.4 wt %, respectively.

Co-Cat 2. A solution of 1.05 g of nickel nitrate hexahydrate (Strem) and 0.23 g of ReCl₃ (Alfa Ceasar) in 20 mL of deionized water was homogeneously impregnated onto 10.00 g of AAS. After drying at 120° C. overnight, the solid was activated in air at 500° C. for 3 h. The resulting solid was called Co-Cat 2, which had the following chemical composition: nickel, 2.1 wt %; rhenium, 1.5 wt %; and Al₂O₃, balance.

Co-Cat 3. Solution A was obtained by dissolving 1.30 g of nickel nitrate hexahydrate (Strem) in 10 mL of deionized water. Solution B was prepared by dissolving 0.011 g of ruthenium acetylacetonate (Strem) in 10 mL of methanol. The mixture of A and B was homogeneously impregnated onto 10.00 g of AAS. After drying at 120° C. overnight, the solid was activated in air at 500° C. for 3 h. The resulting solid was called Co-Cat 3, which had the following chemical composition: nickel, 2.6 wt %; ruthenium, 0.03 wt %; and Al₂O₃, balance.

### Preparation of the Final Hybrid and Reference Catalysts

Hybrid catalysts were obtained by extruding the main component (MCC) with the co-catalyst (Co-Cat) in the following proportions: MCC, 65.6 wt %; Co-Cat, 16.4 wt %; and binder, 18.0 wt %. Bentonite clay (Aldrich) was used as the extruding and binding medium.

The hybrid catalysts-HYB 1(1), HYB 1(2), HYB 1(3), and HYB 1(4)—were prepared using the MCC 1 with the Co-Cat 1(1), Co-Cat 1(2), Co-Cat 1(3), and Co-Cat 2, respectively.

HYB 2 and HYB 3 were obtained by extruding the MCC 2 with Co-Cat 2 and Co-Cat 3, respectively.

Reference catalysts, identified as REF-1 and REF-2, were obtained by extruding MCC-1 and MCC-2 with pure AAS, respectively.

### Catalyst Characterization

The characterization of the catalysts has multiple facets:
1) The various catalyst components were analyzed by atomic absorption spectroscopy for their chemical compositions.
2) The BET total surface area and pore size of these samples were determined by nitrogen adsorption/desorption, using a Micromeretics ASAP 2000 apparatus.
3) The surface acidity was studied using the ammonia adsorption and temperature-programmed desorption (TPD) technique. The analytical system used was a pH meter that had been equipped with an ion-selective electrode (ISE), [Le Van Mao, R.; Al-Yassir, N.; Lu, L.; Vu, N. T.; Fortier, A. Catal. Lett. 2006, 112, 13] which allowed easy assessment of the density of acid sites, as well as their distribution, in terms of strength. In particular, the density of acid sites was determined by NH₃-TPD/back titration, whereas the acid strength profile was recorded with an ISE/pH meter. [Le Van Mao, R.; Al-Yassir, N.; Lu, L.; Vu, N. T.; Fortier, A. Catal. Lett. 2006, 112, 13]
4) Fourier transform infrared (FT-IR) spectra of adsorbed pyridine were used to elucidate the nature of the acid sites. The transmission spectra were recorded with a Nicolet FT-IR spectrometer (Magna 500 model) in the region of 1400-1700 cm⁻¹, with resolution of 4 cm⁻¹. The samples, in the form of a self-supporting thin wafer, were obtained by compressing a uniform layer of powder (sample/KBr mixture≈0.020 g). The thin wafer was then placed in a pyrex cell and outgassed under vacuum (10-2 mbar) at 300° C. for 4 h. Pyridine adsorption then was performed at 100° C. for 2 h. After evacuation at 100° C. for 1 h, the spectra of adsorbed pyridine were recorded at ambient temperature.
5) Thermogravimetric analysis (TGA) and differential thermal analysis (DTA), using a PL Thermal Sciences Model STA-1500 DTA/TGA apparatus, were used to determine the amount of bound species and/or coke deposited onto the catalyst surface. The flow rates of argon (inert gas) and air (oxidative gas) were set at 20 mL/min. The rate of the temperature-programmed heating (TPH) was set at 10° C./min.

Table 7 reports the main physicochemical properties of the catalysts used in this work.

TABLE 7
Main Physicochemical Characteristics of the Hybrid
Catalysts and Their Components^{a}

| | | | Surface Acidity | | | | |
|---|---|---|---|---|---|---|---|
| | | BET | | Medium Acid Site | | Strong Acid Site | |
| | | specific | | | NH₃ | | NH₃ |
| | | surface | Total | | desorption | | desorption |
| catalyst/ | density, d | area, | (mmol/g | mmol/g | peak | mmol/g | peak |
| comp. | (g/cm³) | (m²/g) | of solid) | of solid | temp^{b} (° C.) | of solid | temp^{b} (° C.) |
| ZSM-5 | n.a. | 395 | 0.90 | 0.56 | 245 | 0.34 | 440 |
| (25H^{c}) | | | | | | | |
| AAS | n.a. | 291 | 0.27 | n.o. | | n.o. | |
| MCC-1 | n.a. | 235 | 0.62 | 0.34 | 281 | 0.28 | 411 |
| MCC-2 | n.a. | 211 | 0.79 | 0.45 | 260 | 0.34 | 421 |
| Co-Cat 2 | n.a. | 267 | 0.27 | n.o. | | n.o. | |
| HYB- | 0.372 | 201 | | | | | |
| 1(4) | | | | | | | |
| (fresh) | | | | | | | |
| HYB- | | 157 | | | | | |
| 1(4) | | | | | | | |
| (used)^{d} | | | | | | | |
| HYB-2 | 0.414 | 205 | | | | | |
| (fresh) | | | | | | | |
| HYB-2 | | 196 | | | | | |
| (used)^{d} | | | | | | | |
| REF-1 | 0.333 | 184 | | | | | |
| (fresh) | | | | | | | |
| REF-1 | | 181 | | | | | |
| (used)^{d} | | | | | | | |
| REF-2 | 0.407 | 217 | | | | | |
| (fresh) | | | | | | | |
| REF-2 | | 200 | | | | | |
| (used)^{d} | | | | | | | |

^{a}Legend of abbreviations: n.a.) not applicable; n.o.) not observable.
^{b}Temperature of the corresponding NH₃ desorption peak.
^{c}SiO₂/Al₂O₃ molar ratio = 34, Na₂O content is <0.05 wt %.
^{d}Regenerated in air at 600° C. overnight after >40 h of reaction.

### Characterization of the Feeds (Hydrocarbon Feedstocks)

The composition of various feeds (hydrocarbon feedstocks) was determined using a Hewlett-Packard gas chromatograph (Model 5890, with flame ionization detection (FID)) that was equipped with a Heliflex AT-5 column (Alltech, 30 m, nonpolar). In particular, naphthalene, phenanthrene, and benzo(a)pyrene were used as model molecules for dinuclear, trinuclear, and polynuclear aromatic hydrocarbons (with boiling-point ranges of 200-300° C., 300-400° C., and >400° C.). Table 8 reports the chemical compositions of the feeds used in this work.

TABLE 8
Characteristics of the Hydrocarbon Feedstocks Tested^{a}

| | density, | boiling point, | non-BTX | BTX | | | |
|---|---|---|---|---|---|---|---|
| feedstock | d (g/mL) | bp (° C.) | C5-200° C. | aromatics | 200-300° C. | 300-400° C. | >400° C. |
| light | 0.65 | C5-100 | 95.2 | 4.6 | 0.2 | 0 | 0 |
| naphtha, | | | | | | | |
| L-N | | | | | | | |
| Medium- | 0.729 | 100-150 | 87.6 | 12.2 | 0.2 | 0 | 0 |
| range | | | | | | | |
| naphtha, | | | | | | | |
| m-N^{b} | | | | | | | |
| atmospheric | 0.854 | 240-350 | 4.1 | 0.6 | 17.2 | 78.1 | 0.1 |
| gas oil, | | | | | | | |
| AGO-1 | | | | | | | |
| heavy | 0.86 | 175-400 | 0.1 | 0 | 25.6 | 73.7 | 0.6 |
| atmospheric | | | | | | | |
| gas oil, | | | | | | | |
| AGO-2 | | | | | | | |
| vacuum gas | 0.892 | 350-550 | 2.9 | 0.3 | 2 | 85.9 | 9 |
| oil, VGO | | | | | | | |

^{a}Sources: L-N, m-N, AGO-1, and VGO were kindly supplied by Ultramar Canada; AGO-2 was kindly supplied by Nova Chemicals.
^{b}Also called heavy naphtha.

### Experimental Setup and Testing Procedure

Experiments were performed using a Lindberg tubular furnace with three heating zones. The experimental setup and testing procedure were similar to those reported elsewhere. [Le Van Mao, R.; Vu, N. T.; Al-Yassir, N.; François, N.; Monnier, J. Top. Catal. 2006, 37, 107] Liquids -namely, hydrocarbon feed and water—were injected into vaporizers using two infusion pumps. Steam and vaporized hydrocarbons were thoroughly mixed, and the resulting gaseous mixture was then sent into the tubular reactor (a quartz tube with a length of 140 cm, outer diameter (OD) of 1.5 cm, and inner diameter (ID) of 1.2 cm).

Product liquid and gaseous fractions were collected separately, using a system of condensers. The gas-phase components were analyzed using a Hewlett-Packard Model 5890 FID gas chromatograph that was equipped with a 30-m GS-alumina micropacked column (J & W Scientific), whereas the liquid-phase analysis was performed using the same GC system as that reported in the previous section, “Characterization of the Feeds”. The amounts of hydrogen and carbon oxides evolved were determined using a gas chromatograph (Hewlett-Packard Model HP 5890, with thermal conductivity detection (TCD)) that was equipped with a molecular-sieve packed column.

The testing conditions used were as follows: temperature, 725-740° C.; total weight hourly space velocity (WHSV) (in reference to feed and steam), 1.7-4.0 h⁻¹; catalyst weight, 5.0-7.0 g; steam/feed weight ratio, 0.5-1.0; and feeds, hydrocarbon liquids from light naphtha to vacuum gas oil.

The yield of product i was expressed as the number of grams of product i recovered by 100 g of feed injected (wt %).

It is important to note that the experimental error usually observed on calculated product yields was ±0.2 wt %.

### Effect of the Hydrogen Spilt-Over Species on the Product Yields

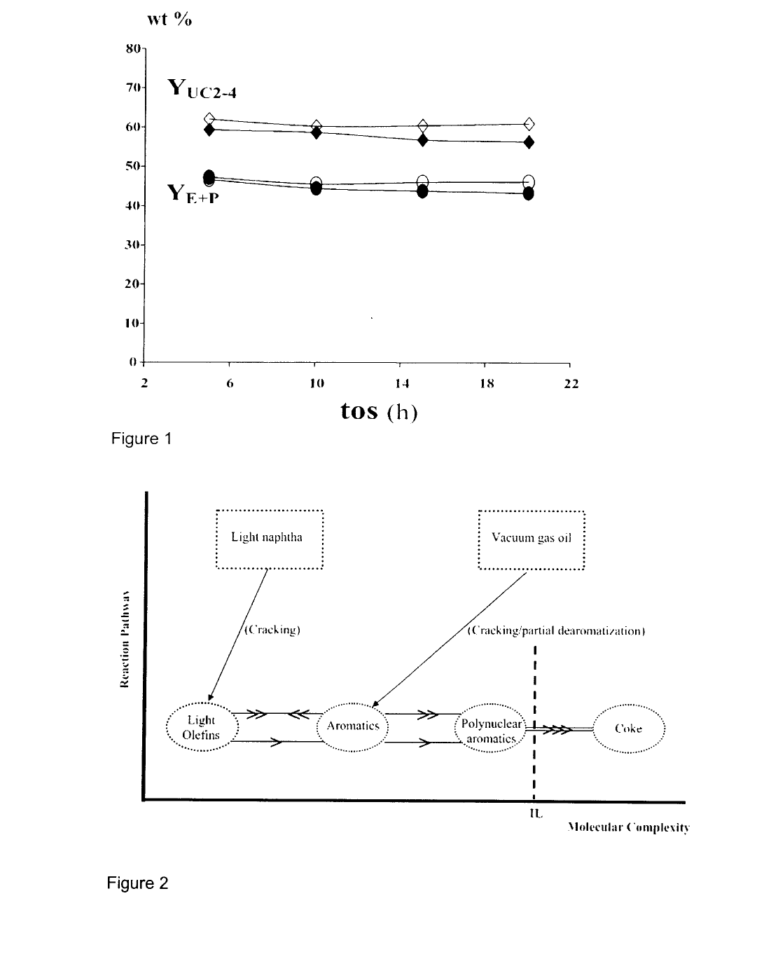

As shown in FIG. 1, the reference catalyst REF-1, which did not contain any “active” co-catalyst, experienced a slow but noticeable activity decay with the time-on-stream (the activity being represented by the combined product yield of ethylene and propylene, and also the yield of C₂-C₄ unsaturated products). However, the activity of hybrid catalyst, HYB-1(1), which contained a nickel loaded co-catalyst, reached a plateau after 10 h of continuous reaction. This activity stabilization of the HYB-1(1) catalyst remarkably evidenced the positive role of the Ni species of the co-catalyst on the cracking sites (MoO₃) of the main catalyst component. It was suggested in our previous work [Le Van Mao, R.; Vu, N. T.; Al-Yassir, N.; François, N.; Monnier, J. Top. Catal. 2006, 37, 107] that transition-metal species (Pt, Pd, Ni, . . . ) incorporated onto the co-catalyst surface could produce very active hydrogen. These species, when spilt-over to the surface of the main catalyst component, could slow the coking phenomena on the latter surface. Taking into consideration the presence of hydrocarbons and steam at a relatively high temperature, these hydrogen species were believed to be produced by steam reforming (and subsequent water-gas shift reaction) over the Ni sites of the co-catalyst. In fact, over the hybrid catalyst HYB-1(1) (and not over the reference catalyst REF-1), the carbon oxides (CO and CO₂) were formed in significant amounts at the beginning of the reaction. However, after an induction period that usually lasted 20-30 min, the production of these carbon oxides stabilized at <0.2 wt %.

It is worth noting that such an interpretation of the experimental results was based on the following facts:
a) Nickel-based catalysts are being used for the production of hydrogen from hydrocarbons, particularly methane, by steam reforming and subsequent reactions. [Chauvel, A.; Lefebvre, G. In Petrochemical Processes; Editions Technip: Paris, 1989; Vols. 1 and 2, and Leprince, P. In ConVersion Processes; Editions Technip: Paris, 2001; p 455].
b) Hydrogen spill-over species are known to have “cleaning properties”, with respect to coke in several reactions. [Pajonk, G. M. In Proceedings of the Second International Conference on SpilloVer, Leipzig, German Democratic Republic, Jun. 12-16, 1989; Steinberg, K.-H., Ed.; p 1.; Conner, W. C., Jr.; Falconner, J. L. Chem. ReV. 1995, 95, 759; Delmon, B. In New Aspects of SpilloVer Effect in Catalysis; Inui, T., Fujimoto, K., Uchijima, T., Masai, M., Eds.; Proceedings of the Third International Conference on Spillover, Kyoto, Japan, Aug. 17-20, 1993; Elsevier: Amsterdam, 1993; p 1.; and (17) Parera, J. M.; Traffano, E. M.; Musso, J. C.; Pieck, C. L. Stud. Surf. Sci. Catal. 1983, 17, 101] In the dehydroaromatization of methane, even small amounts of hydrogen and steam could have some significant coke removal effect. [Ma, H.; Kojima, S.; Kikuchi, R.; Ichikawa, M. Catal. Lett. 2005, 104, 63]

Table 9 provides more results in support of such hypothesis. In fact, when the nickel content of the co-catalyst increased from 1.7 wt % to 3.4 wt %, the production of heavy products, which contained great amounts of polynuclear aromatics, decreased significantly, whereas the yield of light olefins (particularly, ethylene and propylene) visibly increased. All these phenomena occurred while the production of hydrogen increased only by an extremely small amount, compared to the molecular hydrogen produced by cracking (mostly thermal cracking) when the reference catalyst (with no Ni co-catalyst) was used. In fact, the presence of the nickel-loaded co-catalysts in the hybrid catalysts of Table 9 induced small but noticeable increases in the hydrogen production, when compared to that of the REF-1 catalyst (the nickel-free co-catalyst). Such an increase (A) in hydrogen yield was 4.1, 4.8, and 7.5 wt %, for HYB-1(1), HYB-1(2), and HYB-1(3), respectively. On one hand, with the same hybrid catalysts, observed increases in yields of light olefinic products (see Table 9) were as follows: (i) Δ (C₂-C₄ olefins)) 4.5, 4.1, and 8.4 wt %, respectively; Δ (ethylene and propylene)) 4.1, 4.4, and 6.1 wt %, respectively. On the other hand, as previously mentioned, the production of heavy products (200-400⁺° C.), significantly decreased when compared to that of REF-1 catalyst (Δ) 21.3, 22.3, and 34.0 wt %, respectively). Thus, these variations of the product yields had, as a common denominator, the presence of nickel on the co-catalyst surface, which was believed to produce such new hydrogen species by hydrocarbon steam reforming. At this stage of research, the nature of these (spilt-over) hydrogen species (probably atomic species) was not known with absolute certainty. However, what we can say at the moment is that they were very active, because a small amount of these species was sufficient to induce significant changes in the product selectivity (see Table 9).

TABLE 9
Effect of the Co-catalyst on the Product Selectivity of the
Resulting Hybrid Catalyst (Series HYB 1)^{a}

| | | | C2-C4 | ethylene + | | heavy |
|---|---|---|---|---|---|---|
| Hybrid | co-catalyst | Product | Unsaturated | propylene | | products |
| catalyst | (Ni wt %) | hydrogen | (olefins) | (propylene/ethylene) | BTX | (200-400+° C.) |
| REF-1 | AAS | 1.46 | 49.0 | 39.1 | 14.1 | 9.4 |
| | (0.0) | | (45.4) | (0.80) | | |
| HYB-1(1) | Co-Cat 1(1) | 1.52 | 51.2 | 40.7 | 13.4 | 7.4 |
| | (1.7) | | (47.1) | (0.81) | | |
| HYB-1(2) | Co-Cat 1(2) | 1.53 | 51 | 40.8 | 13.3 | 7.3 |
| | (2.8) | | (46.9) | (0.77) | | |
| HYB-1(3) | Co-Cat 1(3) | 1.57 | 53.1 | 41.5 | 11.1 | 6.2 |
| | (3.4) | | (48.8) | (0.79) | | |

^{a}Reaction conditions: temperature, 725° C.; total weight hourly space velocity (WHSV)) 1.7 h⁻¹; catalyst weight, 7 g; feed, AGO-2 (heavy atmospheric gas oil); steam/feed ratio (by weight), 1.0.
All product yields were determined at a reaction time of 10 h.

The data in Tables 10 and 11 suggest that, at the time these product yields were determined (10 h of reaction), the changes in the product selectivity were more significant when heavy feeds, such as vacuum gas oil, were used. In fact, at a relatively short time-on-stream of 10 h, the light naphtha (L-N) did not induce very significant differences in terms of yields of light olefins between the HYB-2 and REF-2 (Tables 10 and 11), meaning that the coke deposition—being quite slow—was not significantly different for both catalyst surfaces. However, the use of VGO feed resulted in much larger differences in terms of yields of light olefins and heavy products (200-400° C. and higher) (see Tables 10 and 11). In particular, with the VGO over the HYB-2 hybrid catalyst, the heavy products determined in the reaction out-stream amounted only to 13 wt % (see Table 11), whereas the REF-2 sample showed a production of ca. 18 wt.% of these heavy products (Table 10). Meanwhile, the yields of light olefins (C₂-C₄ olefins, and also ethylene+propylene) were much higher for the HYB-2 hybrid catalyst (see Tables 10 and 11). In the case of HYB-3 catalyst, when compared to the reference REF-2, these product yields showed even much larger differences; for example, the combined yield of heavy products (boiling-point range of 200-400° C. and higher) and BTX aromatics was 18.4 wt % against 27.6 wt %, i.e. there was a reduction of ca. 33% in the production of aromatics (Tables 10 and 11).

TABLE 10
Performance of the Reference Catalyst REF-2, Using
Various Feedstocks^{a}

Value

| parameter | L-N | m-N | AGO-1 | VGO |
|---|---|---|---|---|
| steam/feed ratio, R (wt/wt) | 0.5 | 0.6 | 0.8 | 1.0 |
| Product yield (wt %) | | | | |
| hydrogen | 1.70 | 1.54 | 1.49 | 1.48 |
| methane | 9.4 | 9.8 | 10.2 | 9.4 |
| ethane | 5.3 | 4.3 | 4.0 | 3.5 |
| ethylene | 22.1 | 21.3 | 22.2 | 21.7 |
| propane | 1.6 | 0.6 | 0.5 | 0.4 |
| propylene | 23.2 | 19.3 | 16.8 | 16.4 |
| butanes | 1.2 | 0.0 | 0.0 | 0.0 |
| n-butenes | 8.8 | 1.9 | 1.6 | 1.3 |
| isobutene | 6.5 | 8.3 | 7.7 | 7.6 |
| 1,3-butadiene | 2.1 | 3.6 | 4.3 | 4.0 |
| C5-200° C., non-BTX | 10.0 | 8.7 | 7.2 | 6.7 |
| benzene | 4.9 | 6.4 | 5.1 | 4.3 |
| Ethyl benzene | 1.4 | 1.1 | 1.9 | 0.7 |
| toluene | 1.4 | 7.2 | 3.4 | 2.9 |
| xylenes | 0.3 | 4.3 | 0.9 | 1.7 |
| 200-400° C. | 0.3 | 1.7 | 12.8 | 17.3 |
| >400° C. | 0.0 | 0.0 | 0.0 | 0.7 |
| ethylene + propylene | 45.3 | 40.6 | 39.0 | 38.1 |
| propylene/ethylene | 1.05 | 0.90 | 0.76 | 0.76 |
| C2═-C4═ | 54.7 | 49.6 | 47.3 | 46.3 |
| C2—C4 unsaturated | 56.8 | 53.2 | 51.6 | 50.3 |
| BTX | 8.0 | 19.0 | 11.3 | 9.6 |

^{a}Reaction conditions: temperature, 725° C.; weight hourly space velocity (WHSV; in reference to only the hydrocarbon feed), 2.0 h−1; and W (catalyst), 5 g. All the data were collected at a reaction time of 10 h.

TABLE 11
Performance of the Hybrid Catalyst HYB-2 (MCC-2
and Co-Cat 2) Using Various Feedstocks^{a}

| | Value | | | | |
|---|---|---|---|---|---|
| parameter | L-N | m-N | AGO-1 | VGO | VGO^{b} |
| steam/feed ratio, R(wt/wt) | 0.5 | 0.6 | 0.8 | 1 | 1 |

product yield(wt %)

| | | | | | |
|---|---|---|---|---|---|
| hydrogen | 1.73 | 1.62 | 1.5 | 1.57 | 1.62 |
| methane | 10.4 | 11.3 | 10.8 | 10.8 | 12.1 |
| ethane | 4.7 | 4.8 | 4.5 | 4.5 | 4.3 |
| ethylene | 22.7 | 24 | 23.3 | 23.3 | 24 |
| propane | 0.7 | 0.5 | 0.4 | 0.5 | 0.6 |
| propylene | 22.9 | 18.6 | 16.9 | 17.8 | 18.6 |
| butanes | 0 | 0 | 0 | 0 | 0 |
| n-butenes | 10 | 1.5 | 1.3 | 1.4 | 1.2 |
| isobutene | 3.8 | 7.3 | 6.8 | 7.9 | 6.8 |
| 1,3-butadiene | 3.2 | 4.2 | 3.1 | 3.7 | 4.5 |
| C5-200° C., non-BTX | 11.3 | 8 | 6.4 | 6.7 | 7.4 |
| Benzene | 6 | 6.5 | 5.5 | 3.8 | 3 |
| Ethyl benzene | 0.2 | 0.8 | 0.6 | 0.5 | 0.5 |
| Toluene | 1.4 | 5 | 3.8 | 2.6 | 2 |
| Xylenes | 0.5 | 2.6 | 1.6 | 1.6 | 1.2 |
| 200-400° C. | 0.6 | 2.3 | 13.5 | 13.1 | 11.4 |
| >400° C. | 0 | 0 | 0 | 0.2 | 0.3 |
| Ethylene + propylene | 45.6 | 42.5 | 40 | 41.1 | 42.6 |
| propylene/ethylene | 1.02 | 0.77 | 0.71 | 0.76 | 0.78 |
| C2═-C4═ | 54.5 | 50.5 | 47.4 | 49.6 | 50 |
| C2-C4_unsaturated | 57.7 | 54.7 | 50.5 | 53.3 | 54.5 |
| BTX | 8.1 | 14.9 | 11.5 | 8.5 | 6.7 |

^{a}Reaction conditions were the same as those given in Table 10.
^{b}Data obtained with HYB-3 using VGO.

All this means that the hybrid catalysts HYB-2 and HYB-3 succeeded to slow the rate of formation of (and/or to dearomatize) these polynuclear aromatics significantly. While the yield of the BTX aromatics also decreased, there was a significant increase in the production of light olefins. However, when lighter feeds such as light naphtha (L-N) were used, there was, in practice, no such large differences in terms of product yields (determined at the same time on-stream) between the reference catalyst (REF-2) and the hybrid catalyst (HYB-2) (see Tables 10 and 11), as similarly reported in FIG. 1 for the HYB-1(1) and REF-1.

These results suggest the following interpretation:
a) Polynuclear aromatics are precursors of coke that is formed through a complex sequence of reactions. [Raseev, S. In Thermal and Catalytic Processes in Petroleum Refining; Marcel Dekker: New York, 2003; p 48] with, as an immediately preceding step, the formation of carboids. [Du, H.; Fairbridge, C.; Yang, H.; Ring, Z. Appl. Catal., A 2005, 294, 1] These condensed, cross-linked polymers can also be formed from aromatic polycyclic hydrocarbons, which directly undergo condensation reactions, resulting in the final formation of carboids. [Raseev, S. In Thermal and Catalytic Processes in Petroleum Refining; Marcel Dekker: New York, 2003; p 48] Therefore, the presence in the feed of these polynuclear aromatics (case of heavy feedstocks such as the VGO) accelerates the formation of coke, thus leading to a more rapid activity decay.
b) The presence of active hydrogen species coming from the nickel-bearing co-catalyst surface is believed to partially retard such coking reactions by their de-aromatizing action on the “normal” sequence of coke formation or/and directly on the polynuclear aromatics of the feed, as depicted in FIG. 2. For the moment, we have no direct evidence of their action on the reaction intermediates. However, the “indirect” evidence stands on two quite suggestive facts: (i) their influence on the product yields (see Table 9) and (ii) their effect on the carbonaceous deposition and the adsorbed species on the catalyst surface (see Table 12).
c) The fact that, after 10 h time-on-stream (a very short period of time), the hybrid catalysts had almost little effect on lighter hydrocarbon feedstocks, whereas heavier feedstocks were significantly affected, suggests that the dearomatization of these existing polynuclear aromatics was predominant, compared to the retarding effect on their formation from smaller hydrocarbons of the feed (FIG. 2).

TABLE 12
Tabulated Results for the DTA/TGA Analysis of Reference
(REF-2) and Hybrid (HYB-2) Catalysts in Various Environments^{a}

| | Value | | | |
|---|---|---|---|---|
| | REF-2 | | HYB-2 | |
| parameter | in argon | in air | in argon | in air |
| weight loss | 29.6 wt % | 21.8 wt % | 31.5 wt % | 6.3 wt % |
| temperature | 807° C. | 552° C. | 682° C. | 470° C. |
| assumed | thermal | combustion | thermal | combustion |
| type of | de- | | decomposition | |
| reaction | composition | | | |
| (DTA) | | | | |

^{a}The desorption of adsorbed species (water and others) is not reported herein.

### Coke and its “Advanced” Precursors

The previous interpretation of catalytic results was confirmed by the TGA/ DTA study of the coked catalysts, i.e., with heavy feeds (in our case, VGO), hybrid catalysts, having active sites present on the co-catalyst surface, were capable of activating hydrogen and, thus, producing less coke than reference catalysts. In fact, Table 12 reports the DTA/TGA results of coked reference (REF-2) and hybrid (HYB-2) catalysts. Each coked catalyst was submitted first to a temperature-programmed heating (TPH) under inert atmosphere (argon) from ambient temperature up to 900° C. and then, after a rapid cooling to ambient temperature, to another TPH from ambient temperature to 800° C., but this time, in air.

Thus, it can be observed (from Table 12) that (i) in an argon atmosphere, there was (predominantly) thermal decomposition of the heavy species firmly bound to the catalyst surface (and which were not desorbed in diethyl ether [Le Van Mao, R.; Dufresne, L. A.; Yao, J.; Yu, Y. Appl. Catal., A 1997, 164, 81]), which led to the same weight loss for both catalysts (these bound species were believed to be “advanced” precursors of coke); and (ii) in the subsequent heating step that was performed in an oxidative atmosphere (air), there was combustion of the coke deposition: the weight loss experienced by the hybrid catalyst was less than one-third of that experienced, under the same conditions of analysis, by the reference catalyst.

Moreover, the temperatures of thermal decomposition and coke combustion observed with the hybrid catalyst were significantly lower than those recorded with the reference catalyst. This suggests that the species bound to (and the coke deposited on) the hybrid catalyst surface were much lighter than the corresponding species on the reference catalyst surface, where there were no hydrogen spilt-over species in action.

On the other hand, the combined action of the two components in the hybrid catalyst did not result in negative effect on the yields of light olefins. Instead, significant increases in their production were observed, probably because more cracking sites on the main catalyst component were available for much longer reaction times.

### Effect of the Cracking Component (Main Catalyst Component) on the Product Propylene/Ethylene Ratio.

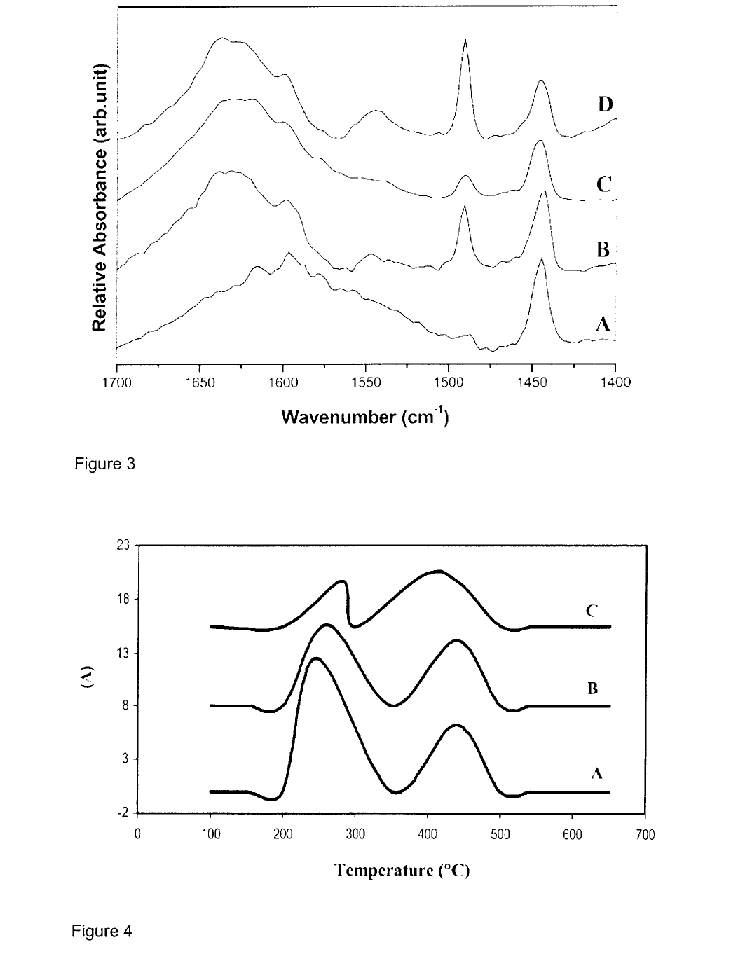

Note that the hybrid catalyst HYB-1(4) showed yields in product light olefins that are much lower than those of HYB-2 (see Tables 13 and 11, respectively). They both contained the same co-catalyst (Co-Cat 2), but they differed from each other by the main catalyst component (i.e., MCC-1 and MCC-2) used in the preparation of the final catalyst (HYB-1(4) and HYB-2, respectively). On the MCC-1 surface, the cracking sites were acid sites developed by the MoO₃ species [Kung, H. H. In Transition Metal Oxides: Surface Chemistry and Catalysis; Delmon, B., Yates, J. T., Eds.; Elsevier: Amsterdam, 1989; Vol. 45, p 83] deposited on quasineutral yttria-stabilized aluminum oxide (AAS; see Table 7). Such surfaces (MCC-1 and AAS) do not show any significant Brønsted acidity (1546 cm-1) besides the Lewis acid sites (1450 cm⁻¹) [Lynch, J. In Analyse Physico-chimique des Catalyseurs Industriels; Editions Technip: Paris, 2001; p 273] (see FIGS. 3C and 3A). Instead, the lanthanum-stabilized ZSM-5 zeolite was used in the preparation of the MCC-2 whose surface exhibited, compared to that of the MCC-1, a larger amount of Brønsted acid sites (see FIG. 3D), a higher acid sites density (Table 7), and a higher density of slightly stronger acid sites (see Table 7; higher density and slightly higher desorption temperature for peak S). The major contributor to this enhanced acidity was the ZSM-5 zeolite (see FIG. 3B and FIG. 4).

TABLE 13
Performance of Hybrid Catalyst HYB-1(4) and Reference
Catalyst REF-1^{a}

| | |
|---|---|
| REF-1 | HYB-1(4) |

| parameter | at 725° C. | at 725° C. | at 740° C. |
|---|---|---|---|
| Product yield (wt %) | | | |
| hydrogen | 1.61 | 1.62 | 1.69 |
| methane | 9.9 | 10.9 | 11.8 |
| ethane | 4.0 | 3.9 | 3.8 |
| ethylene | 18.8 | 19.6 | 22.8 |
| propane | 0.5 | 0.5 | 0.4 |
| propylene | 19.5 | 19.8 | 19.4 |
| butanes | 1.7 | 1.7 | 1.4 |
| n-butenes | 13.3 | 12.5 | 9.8 |
| isobutene | 7.4 | 6.9 | 5.3 |
| 1,3-butadiene | 2.6 | 2.6 | 3.5 |
| C5-200° C., non-BTX | 15.4 | 12.1 | 11.2 |
| benzene | 4.1 | 6.0 | 6.4 |
| Ethyl benzene | 0.1 | 0.2 | 0.2 |
| toluene | 0.6 | 1.1 | 1.3 |
| xylenes | 0.2 | 0.3 | 0.4 |
| 200-400° C. | 0.2 | 0.4 | 0.7 |
| >400° C. | 0.0 | 0.0 | 0.0 |
| Ethylene + propylene | 38.3 | 39.4 | 42.2 |
| propylene/ethylene | 1.03 | 1.01 | 0.85 |
| C2═-C4═ | 51.6 | 51.8 | 52.3 |
| C2—C4 unsaturated | 54.2 | 54.4 | 55.8 |
| BTX | 4.9 | 7.6 | 8.2 |

^{a}Reaction conditions were the same as those of Table 4. Results were obtained with a L-N feed.

Therefore, to have the same level of conversion, catalytic testing was performed on the HYB-1(4) (and other catalysts using the same AAS support) at a significantly higher temperature (i.e., 740° C. instead of 725° C.; see FIG. 1 and Table 13). Such higher reaction temperature led to a lower product propylene/ethylene ratio (FIG. 1 and Table 13), as usually observed with thermal or steam cracking. Thus, the use of ZSM-5 zeolite containing hybrid catalysts, tested at the standard reaction temperature (725° C.) and particularly with light hydrocarbon feedstocks, resulted in a higher combined yield of ethylene and propylene and a higher propylene/ethylene ratio (Table 11, L-N as feed). According to Corma et al., [Corma, A.; Melo, F. V.; Sauvanaud, L.; Ortega, F. Catal. Today 2005, 107-108, 699] in the FCC naphtha cracking, the selectivity to propylene increases when hydrogen-transfer reactions are minimized using shape-selective catalysts (such as the ZSM-5 zeolite). However, we believe that, in our case, the use of higher temperature to compensate the lower surface acidity of the nonzeolitic main component such as in the HYB-1(4) was the main cause for such significant variations of the propylene/ethylene ratio.

### Conclusion

We have shown in this work that the hydrogen spill-over effect may play a key role in improving the catalytic activity of the hybrid catalysts of the TCC process. Because the latter process has been developed for the production of light olefins, this effect, when fully controlled, may advantageously contribute to (i) increasing the yields of light olefins, (ii) producing less heavy compounds, and (iii) lengthening the run length when a fixed bed (and tubular) reactor is used.

The concept of hybrid catalysts that contain co-catalysts being capable of producing hydrogen spill-over species is proven to have powerful dearomatizing/ring opening properties. Therefore, the use of such catalysts may reduce polynuclear aromatics in middle-distillate fuels, which are known for “producing particulates in the exhaust gases and, in addition, having poor ignition properties (i.e., low cetane number in diesel fuel and high smoke point in jet fuel”). [Baeza, P.; Villarroel, M.; Avila, P.; Lopez Agudo, A.; Delmon, B.; Gil-Llambias, F. J. Appl. Catal., A 2006, 304, 109] More-efficient hydrotreating catalysts would be prepared using this concept of long-distance hydrogen spillover. [Conner, W. C., Jr.; Falconner, J. L. Chem. ReV. 1995, 95, 759 and Dufresne, L. A.; Le Van Mao, R. Catal. Lett. 1994, 25, 371]

Finally, note that recent progress in the understanding of these (hydrogen spillover) phenomena will result in very important applications in several sectors of catalysis, fuel-cell technology, and material science. [Yang, H.; Chen, H.; Chen, J.; Omotoso, O.; Ring, Z. J. Catal. 2006, 243, 36; Li, X.; Yang, J.; Liu, Z.-W.; Asami, K.; Fujimoto, K. J. Jpn. Pet. Inst. 2006, 49, 8; Li, Y.; Yang, R. T. J. Am. Chem. Soc. 2006, 128, 8136; and Panayotov, D. A.; Yates, J. T., Jr. J. Phys. Chem. C 2007, 111, 2959]

The supported Ni co-catalyst surface of the thermocatalytic cracking (TCC) hybrid catalyst produces very active hydrogen species. Such species, once transferred (spilt-over) onto the surface of the main catalyst component (cracking sites), interact with the adsorbed reaction intermediates, resulting in a decreased formation of coke precursors (polynuclear aromatics) and the dearomatization/ring-opening of some heavy compounds of the feed. Simultaneously, there is a significant increase in the product yields of light olefins, particularly ethylene and propylene. Analysis of reaction products after 10 h of continuous reaction shows the very significant effects of these co-catalysts on heavy feedstocks such as vacuum gas oils, although the amounts of these (spilt-over) hydrogen species are very small, in comparison to the molecular hydrogen produced by the cracking reactions.

### Example 4

### Monocomponent Catalysts

First, the catalyst components listed in Table 14 were prepared.

TABLE 14
Catalyst Components

| Catalyst component | Description |
|---|---|
| Y—Al | Alumina + Y₂O₃ |
| Y—Al (Mo, Ce, P) | Y—Al + MoO₃ + CeO₂ + P |
| ZSM-5 (Mo, Y, P) | ZSM-5 + MoO₃ + Y₂O₃ + P |
| ZSM-5 (Mo, La, P) | ZSM-5 + MoO₃ + La₂O₃ + P |

Y—Al. Yttria-stabilized aluminum oxide (herein referred to as Y—Al) was prepared by the sol-gel technique. It is a thermally and hydrothermally stable support.

Solution A was prepared by dissolving 450.0 g of Al s-butoxide (Strem Chemicals) in 300 ml of 2-butanol. Solution B was obtained by dissolving 42.5 g of Y(III) nitrate hexahydrate (Strem) in 100 ml of methanol (Aldrich). Solution B was added—under vigorous stirring, always at room temperature—into solution A. When the slurry was apparently homogeneous, 80 ml of water were rapidly added. The hydrolysis reaction immediately started resulting in a noticeable heat release. The slurry became stirrable after a few minutes. This slurry was then left under moderate stirring at room temperature for 4 hours. The evaporation to almost dryness was carried out with very moderate heating for several days. The (still wet) solid was put in an oven at 285° C. After 2 hours at 285° C., the oven was heated at 750° C. for 5 hours.

The resulting mesoporous solid comprised about 10 wt % of Y₂O₃ based on the total weight of the solid. Its surface area as determined by the BET method was 290 m²g⁻¹.

Y—Al (Mo, Ce, P). A catalyst component comprising Y—Al and Mo, Ce, and P [herein referred to as Y—Al (Mo, Ce, P)] was prepared.

A solution obtained by dissolving 12.08 g of ammonium molybdate tetrahydrate (Strem) in 250 ml of H₃PO₄ 2N, was rapidly added (under thorough stirring) to 100.0 g of Y—Al. This slurry was left at room temperature (no stirring) for 30 minutes and then dried at 120° C. for 2 hours. Then a solution of 2.68 g of Ce (III) nitrate hexahydrate (Strem) in 50 ml of distilled water was added to the solid under moderate stirring. After 15 minutes left at room temperature, the solid was dried in an oven at 120° C. overnight and then activated at 500° C. for 3 hours.

The resulting solid comprised 4.4 wt % P, about 8.6 wt % MoO₃ and about 0.9 wt % CeO₂ based on the total weight of the solid.

ZSM-5 (Mo, Y, P). 46.70 g of ZMS-5 zeolite (acidic form or 50H, purchased from Zeochem, Switzerland) were impregnated with a solution obtained by dissolving 5.10 g of Y(III) nitrate hexahydrate (Strem) in 50 ml of distilled water. After drying at 120° C., the solid was activated at 500° C. for 3 hours. The solution prepared by dissolving 6.12 g of ammonium molybdate in 85 ml of H₃PO₄ 3N was rapidly added (under thorough stirring) to the previously obtained solid. After drying at 120° C. overnight and subsequent activation at 500° C. for 3 h, the solid showed the following contents: MoO₃=9.1 wt %, Y=2.5 wt % and P=5.0 wt %

ZSM-5 (Mo, La, P). The same procedure was used for the preparation of zeolite (Mo, Y, P) main catalyst component except that the Y(III) nitrate hexahydrate was substituted by La(III) nitrate hydrate (4.06 g). Content of La: 3.5 wt %.

Nickel-Containing Monocomponent Catalysts. Different nickel-containing monocomponent catalysts were prepared by impregnating nickel onto Y—Al (Mo, Ce, P), ZSM-5 (Mo, Y, P) and ZSM-5 (Mo, La, P). These catalysts and their composition are described in the following table:

TABLE 15
Monocomponent Catalysts

| Catalyst | Description |
|---|---|
| MONO-01 | Y—Al (Mo, Ce, P) + 1.7% Ni + bentonite clay |
| MONO-02 | Y—Al (Mo, Ce, P) + 2.0% Ni + bentonite clay |
| MONO-03 | Y—Al (Mo, Ce, P) + 2.4% Ni + bentonite clay |
| MONO-04 | Y—Al (Mo, Ce, P) + 3.3% Ni + bentonite clay |
| MONO-05 | ZSM-5 (Mo, Y, P) + 2.0% Ni + bentonite clay |
| MONO-06 | ZSM-5 (Mo, La, P) + 2.0% Ni + bentonite clay |

The solutions obtained by dissolving X g of Ni (II) nitrate hexahydrate (Strem) in 36 ml of water, were impregnated into 20.0 g of Y—Al (Mo, Ce, P), X being equal to 1.70, 2.00, 2.40 or 3.20 g. The impregnation of Ni into the zeolite containing components (20 g) was carried out with 2.00 g of Ni(II) nitrate hexahydrate. After drying at 120° C. overnight, the solid were activated at 500° C. for 3 hours.

The resulting solids showed the following Ni concentrations: 1.7, 2.0, 2.4 and 3.3 wt % based on the total weight of the solid for MONO-01 through MONO-04, respectively and 2.0 wt % of Ni for MONO-05 and MONO-06. These solids were then extruded with bentonite clay (Aldrich, 18 wt % based on the total weight of the extruded catalyst). After drying at 120° C. overnight, the catalyst extrudates were finally activated at 740° C. for 3 hours.

### Comparative Example 2

### Reference Catalysts

The catalyst component Y—Al (Mo, Ce, P) was extruded with bentonite clay (Aldrich, 18 wt % based on the total weight of the extruded catalyst). The resulting extrudates were dried at 120° C. overnight, and finally activated at 740° C. for 3 hours. This catalyst and its components are described in Table 16.

The catalyst component ZSM-5 (Mo, La, P) was extruded with bentonite clay (Aldrich 18 wt % based on the total weight of the extruded catalyst). The resulting extrudates were dried at 120° C. overnight, and finally activated at 740° C. for 3 hours. This catalyst and its components are also described in Table 16.

TABLE 16
Reference Catalysts

| Reference Catalysts | Description |
|---|---|
| REF-01 | Y—Al (Mo, Ce, P) + bentonite clay |
| REF-02 | ZSM-5 (Mo, La, P) + bentonite clay |

### Example 5

### Catalyst Testing

The catalysts of Example 4 and Comparative Example 2 have been tested for their performances. The experiments were performed using a Lindberg tubular furnace with three heating zones. The experimental set-up and the testing procedure were similar to those reported elsewhere [R. Le Van Mao, N. T. Vu, N. Al-Yassir, N. François and J. Monnier, Topics in Catalysis 37 (2-4), (2006), 107]. Liquids, namely gas oil or light naphtha and water, were injected into a vaporizer using two infusion pumps. Nitrogen was used as carrier gas. The gaseous stream was then injected into the tubular reactor (quartz tube of 140 cm in length, 1.5 cm O.D. and 1.2 cm I.D.).

The feed used for testing MONO-01 through MONO-04, and REF-01, was an atmospheric gas oil having the following properties: boiling points=175-400° C. and density=0.860 g cm⁻³. The other testing conditions (testing conditions A) were as follows:
weight of catalyst: 7.0 g;
weight hourly space velocity (WHSV, i.e. weight of gas oil and water injected per hour per weight of catalyst): 1.72 h⁻¹;
steam/gas oil weight ratio: 1.0;
nitrogen flow-rate: 3.0 cm³.min⁻¹; and
temperature: 725° C.

Product liquid and gaseous fractions were collected separately and analyzed by gas chromatography. The yield of product (i) was expressed in grams of product recovered by 100 g of gas oil (or naphtha) injected (wt %). Experimental errors were less than 1 wt %.

Catalytic data obtained with monocomponent catalysts MONO-01-MONO-04 and reference catalyst REF-01 are reported in the following table.

TABLE 17
Performance of the Monocomponent Catalysts MONO-01
to MONO-04 and Reference Catalyst REF-01 (Testing Condition A,
Gas Oil Feed)

| | Catalyst | | | | | | |
|---|---|---|---|---|---|---|---|
| | | MONO- | MONO- | MONO- | MONO- | MONO- | MONO- |
| | REF-01 | 01 | 02 | 03 | 03* | 04 | 04* |
| Wt % Ni in catalyst | 0 | 1.7 | 2.0 | 2.4 | 2.4 | 3.2 | 3.2 |
| based on the weight | | | | | | | |
| of the catalyst | | | | | | | |
| excluding the | | | | | | | |
| bentonite | | | | | | | |

Product distribution (wt %)

| | | | | | | | |
|---|---|---|---|---|---|---|---|
| C₂═ | 21.7 | 22.6 | 22.5 | 22.7 | 22.3 | 22.7 | 21.1 |
| C₃═ | 17.3 | 17.8 | 18.3 | 18.2 | 18.1 | 19.6 | 17.4 |
| C₄═ | 6.4 | 6.6 | 6.8 | 6.5 | 6.3 | 7.2 | 6.4 |
| Butadiene | 3.6 | 4.2 | 4.3 | 4.2 | 4.1 | 4.7 | 4.3 |
| BTX aromatics | 14.1 | 13.6 | 13.5 | 12.8 | 13.0 | 11.3 | 14.5 |
| 200-400° C. | 9.5 | 8.3 | 7.7 | 8.0 | 8.7 | 6.2 | 8.8 |
| Heavy hyd. | 0.0 | 0.0 | 0.0 | 0.0 | 0.0 | 0.0 | 0.0 |
| (>400° C.) | | | | | | | |
| Methane | 11.5 | 10.6 | 10.9 | 11.5 | 11.8 | 9.8 | 11.4 |
| Hydrogen | 1.46 | 1.53 | 1.54 | 1.54 | 1.50 | 1.61 | 1.46 |
| Ethylene + | 39.0 | 40.4 | 40.8 | 40.9 | 40.4 | 42.3 | 38.5 |
| propylene | | | | | | | |
| Propylene/ethylene | 0.80 | 0.79 | 0.81 | 0.80 | 0.81 | 0.86 | 0.82 |
| ratio | | | | | | | |
| C₂═ + C₃═ + | 49.0 | 51.2 | 51.9 | 51.6 | 50.8 | 54.2 | 49.2 |
| C₄═ + butadiene | | | | | | | |

*= data recorded after two days of continuous reaction.

The feed used for testing MONO-05, MONO-06 and REF-02 was a light naphtha having the following properties: boiling point=C₅-100° C., density=0.650 g cm⁻³. The other testing conditions (testing conditions B) were as follows:
weight of catalyst=5.0 g;
weight hourly space velocity (WHSV, i.e. weight of gas oil and water injected per hour per weight of catalyst: 2.00 h⁻¹;
steam/naphtha weight ratio: 0.5;
nitrogen flow-rate: 3.0 cm³min⁻¹; and
temperature=725° C.

The catalytic data obtained with monocomponent catalysts MONO-05 and MONO-06 are reported in the following table.

TABLE 18
Performance of the monocomponent catalysts MONO-05,
MONO-06 and REF-02.

Catalyst

| Product distribution (wt %) | MONO-05 | MONO-06 | REF-02 |
|---|---|---|---|
| C₂═ | 24.0 | 24.1 | 22.8 |
| C₃═ | 23.0 | 22.5 | 19.7 |
| C₄═ | 6.6 | 7.0 | 5.7 |
| Butadiene | 4.0 | 3.7 | 3.1 |
| BTX aromatics | 7.9 | 9.2 | 9.8 |
| 200-400° C. | 0.5 | 0.5 | 0.6 |
| Heavy hyd. (>600° C.) | 0.0 | 0.0 | 0.0 |
| Methane | 11.6 | 10.9 | 10.5 |
| Hydrogen | 1.64 | 1.64 | 1.48 |
| Ethylene + propylene | 47.0 | 46.6 | 42.5 |
| Propylene/ethylene ratio | 0.96 | 0.93 | 0.90 |
| C₂═ + C₃═ + C₄═ + butadiene | 57.6 | 57.3 | 51.3 |

The incorporation of Ni onto the catalyst components Y—Al (Mo, Ce, P) and ZSM-5 (Mo, Y, P) and ZSM-5 (Mo, La, P) results in catalysts having very interesting properties. In fact, it is clear from the above tables that Ni exerted some significant beneficial effects on the catalytic activity. In particular, Table 17 shows that the production of light olefins (particularly, ethylene and propylene) and unsaturated light hydrocarbons was higher for these monocomponent catalysts than that for the reference catalyst and increased with increasing Ni loading. At the same time, the amount of polyaromatic hydrocarbons (200-400° C.) decreased significantly. This is indicative that the catalyst caused the ring opening of these polyaromatic hydrocarbons thereby producing light olefins.

The hydrogen production for these catalysts increased noticeably meaning that the hydrogen species “in situ” formed were extremely more active than the molecular hydrogen produced by the (thermal and catalytic) cracking reactions. Thus, with the decrease of the production of the heavy liquid fraction, the product spectrum was beneficially shifted towards the lighter unsaturated products (light olefins, particularly ethylene and propylene).

All this indicates a more efficient action of the Ni-containing catalyst component in terms of production and transfer of hydrogen spilt-over species, which resulted in enhanced hydrogenation of these heavy liquid products and enhanced ring-opening action on the (condensed) poly-aromatic hydrocarbons (PAH) at the level of the acid sites. In fact, these heavy liquid products are usually assumed to contain a large proportion of PAH which normally are the precursors of coke (carbonaceous deposit which causes catalyst activity decay). Thus, the reduction of coke formation on the main catalyst increased the catalyst on-stream stability which was effectively observed with the present hybrid catalysts.

The monocomponent catalyst MONO-04 (Ni loading of 3.3 wt %) exhibited a very good catalytic performance. However, its activity started to decline after a few (2) days of continuous reaction. Therefore, if monocomponent catalysts are to be used for a long period of time, it would be advisable to keep the concentration of incorporated Ni up to a maximum level of 3 wt %, which as can be seen from Table 17 still exhibited very good catalytic performances after two days of continuous reaction. In any cases, monocomponent catalysts with higher concentration of Ni may be successfully used for short periods of time.

### Example 6

### Procedure for the Production of Light Olefins From Raw Pyrolysis Gasolines, Steam-Cracking Fuel Oils or Other Diolefinic-Olefinic Hydrocarbons Containing Liquids, Using the Thermo-Catalytic Cracking Catalysts

This example relates to a procedure for the production of light olefins by catalytically converting the raw pyrolysis gasolines or fuel oils produced by the steam-cracking of various (gaseous or liquid) hydrocarbon feedstocks. Other liquid feedstocks containing diolefinic-olefinic or olefinic hydrocarbons can also be used. In the case of the steam-cracking liquid products that are used as feeds for this conversion, it is very advantageous to dilute them first with medium-range naphtha. With the mixtures of naphtha and pyrolysis gasoline, depending on the composition of the feed and the reaction temperature used, ethylene or propylene is primarily produced. The catalysts used in this invention are similar to those used in the thermo-catalytic cracking of petroleum naphthas or gas oils (see the hybrid catalysts for the TCC process above). The reaction products are light olefins, primarily ethylene and propylene, while other commercially valuable compounds such as BTX aromatics, are also produced or essentially preserved if already present in the feed.

Catalyst Preparation.

Preparation of Yttria-Stabilized Alumina Oxide Support (AAS).

The yttria-stabilized alumina oxide was prepared using a (sol-gel) procedure that was similar to that reported by Le Van Mao et al [R. Le Van Mao, N. T. Vu, N. Al-Yassir, N. François, J. Monnier, Top. Catal., 37 (2006), 107]. After the solid material has been activated at 750° C. for 3 h, it shows the following chemical composition: 10 wt % Y₂O₃, with the balance being Al₂O₃.

Preparation of the Main Catalyst Component (MCC).

30 g of ZSM-5 zeolite/50H (powder, acid form, silica/alumina molar ratio=50, purchased from Zeochem) were added to an aqueous solution of 5 wt % lanthanum nitrate hydrate (Strem Chemicals). The suspension was heated at 80° C. under mild stirring for 2 h. The solid obtained by filtration was washed on the filter with 300 mL of deionized water, then dried at 120° C. overnight and finally activated at 500° C. for 3 h.

20.00 g of the resulting solid (La-HZSM-5) were homogeneously impregnated with a solution of 2.78 g of ammonium molybdate hexahydrate (Aldrich) in 34 mL of 3N H₃PO₄ and 10 mL of deionized water. The solid was dried at 120° C. overnight and then activated at 500° C. for 3 h. Its chemical composition was as follows: MoO_{3,} 8.4 wt %; La₂O₃, 1.7 wt %; phosphorus, 4.0 wt %; and zeolite, balance.

Preparation of the Co-Catalyst (Co-Cat).

Solution A was obtained by dissolving 1.31 g of nickel nitrate hexahydrate (Strem) in 10 mL of deionized water. Solution B was prepared by dissolving 0.017 g of ruthenium acetylacetonate (Strem) in 10 mL of methanol. The mixture of A and B was homogeneously impregnated onto 10.00 g of AAS. After drying at 120° C. overnight, the solid was activated at 500° C. for 3h. The resulting solid (Co-Cat) had the following chemical composition: nickel, 2.6 wt %, ruthenium, 0.05 wt %; and Al₂O₃ (and Y₂O₃), balance.

Preparation of the Final Hybrid Catalyst.

The hybrid catalyst (HYB) was obtained by extruding the main component (MCC) with the co-catalyst (Co-Cat) in the following proportions: MCC, 65.6 wt %; Co-Cat, 16.4 wt %; and binder (bentonite clay, Aldrich), 18.0 wt %.

The reference (hybrid) catalyst, identified as REF, was obtained by extruding MCC with pure AAS.

Experimental Set-Up and Testing Procedure.

Experiments were performed using a Lindberg tubular furnace with three heating zones. The experimental set-up and testing procedure were similar to those reported elsewhere [R. Le Van Mao, N. T. Vu, N. Al-Yassir, N. François, J. Monnier, Top. Catal., 37 (2006), 107]. Liquids—namely, hydrocarbon feed and water—were injected into vaporizers using two infusion pumps. Steam and vaporized hydrocarbons were thoroughly mixed, and the resulting gaseous mixture was then sent into the tubular reactor (a quartz tube with a length of 140 cm, outer diameter (OD) of 1.5 cm, and inner diameter (ID) of 1.2 cm). It is worth noting that because raw pyrolysis gasolines, mostly the PY-GAS (B), and also pyrolysis fuel oils, contained diolefins and other molecules which might undergo polymerization at high temperature (thus resulting in an unwanted encrusting of the internal walls of the feeding system), the vaporization and their mixing with steam of such gasolines or fuel oils, should be carried out a temperature not exceeding 280-300° C. The use of blends (heavy naphtha with PY-GAS or fuel oil) might also prevent such encrusting phenomena.

Product liquid and gaseous fractions were collected separately, using a system of condensers. The gas-phase components were analyzed using a Hewlett-Packard Model 5890 FID gas chromatograph that was equipped with a 30m GS-alumina micropacked column (J & W Scientific), whereas the liquid-phase analysis was performed with another Hewlett-Packard 5890 FID gas chromatograph that was equipped with a Heliflex AT-5 column (Alltech, 30m, non polar). In particular, naphthalene, phenanthrene, and benzo(a) pyrene were used as model molecules for some heavy aliphatics, dinuclear, trinuclear, and polynuclear aromatic hydrocarbons (with boiling-point ranges of 150-300° C., 300-400° C., and >400° C.). It is worth noting that liquid products of the reaction carried out with raw pyrolysis gasolines (PY-GAS) might contained some emulsions that can be “dissolved” by thorough treatment (drying) with zeolite 3A.

The testing conditions used were as follows: weight hourly space velocity (WHSV), in reference to feed, 2 h⁻¹; steam/feed weight ratio, 0.5, duration of a run, 5 h.

Finally, the yield of product i was expressed as the number of grams of product i recovered by 100 g of feed injected (wt %).

Results of Catalytic Tests with Medium-Range Naphtha.

In the TCC process, 725° C. was found to be the best reaction temperature for obtaining the highest combined yield of ethylene and propylene from most of liquid feedstocks (naphthas and gas oils) [See Example 3 above]. However, this invention shows that it is more advantageous to carry out the TCC conversion of medium-range naphtha at a significantly lower temperature. In fact, at 625-675° C., the combined yield of ethylene and propylene (Table 18) was at least as high as that observed at 725° C. [(last column of Table 18), with a product ratio propylene/ethylene much higher than 1.0. As propylene is nowadays the light olefin that the industry is focused on, this is actually an advantage. The medium-range naphtha used (hereafter called heavy naphtha or H.N.) was kindly supplied by Ultramar Canada Inc. and exhibited the following characteristics: density=0.745 g/mL, boiling point range=100-150° C. Its chemical composition, as determined by gas chromatography analysis, was as follows: non-BTX (C₅-150° C.) hydrocarbons=87.6 wt %, BTX aromatics=12.2 wt %, (150-300° C.)=0.2 wt % and over 300° C.=0 wt %.

TABLE 18
Catalytic data obtained with heavy naphtha (H.N.) at
various reaction temperatures
(other reaction parameters = see experimental section)

Temperature (° C.)

| | 625 | 650 | 675 | 725* |
|---|---|---|---|---|
| Hydrogen | 1.4 | 1.5 | 1.6 | 1.6 |
| Methane | 1.9 | 3.2 | 5.1 | 11.3 |
| Ethane | 2.4 | 2.8 | 3.3 | 4.8 |
| Ethylene | 12.3 | 15.0 | 18.1 | 24.0 |
| Propane | 4.0 | 3.6 | 3.0 | 0.5 |
| Propylene | 28.4 | 29.7 | 29.7 | 18.6 |
| Butanes | 1.1 | 0.7 | 0.6 | 0.0 |
| Isobutene | 9.0 | 9.3 | 8.9 | 7.3 |
| n-butenes | 4.2 | 3.2 | 3.4 | 1.5 |
| 1,3-butadiene | 0.2 | 0.4 | 0.6 | 4.2 |
| C₅—C₉ non-arom. | 25.9 | 19.8 | 14.1 | 8.0 |
| Benzene | 1.1 | 2.2 | 3.4 | 6.5 |
| Ethylbenzene | 0.7 | 0.6 | 0.4 | 0.8 |
| Toluene | 4.3 | 4.4 | 4.8 | 5.0 |
| Xylenes | 3.0 | 2.9 | 2.7 | 2.6 |
| (150-300° C.) | 0.2 | 0.3 | 0.3 | 2.0 |
| (300-400° C.) | 0.0 | 0.0 | 0.0 | 0.3 |
| (>400° C.) | 0.0 | 0.0 | 0.0 | 0.0 |
| Ethylene + propylene | 40.7 | 44.7 | 47.8 | 42.5 |
| Ethylene/propylene | 0.43 | 0.50 | 0.61 | 0.77 |
| C₂—C₄ olefins | 53.9 | 57.2 | 60.1 | 51.3 |
| BTX aromatics | 9.0 | 10.1 | 11.3 | 14.9 |
| Other liquid products | 0.2 | 0.3 | 0.3 | 2.3 |

*data from Example 3.

Results of Catalytic Tests with (Raw) Pyrolysis Gasolines, Alone.

Two (raw, i.e., non-hydrogenated) pyrolysis gasolines (PY-GAS), kindly provided by Petromont Inc, (Montreal, Canada) were used: type B or “heavy PY-GAS” and type A or “light PY-GAS”. The PY-GAS (A) contained more BTX aromatics (particularly benzene) while the PY-GAS (B) contained more “heavy” unsaturated hydrocarbons (boiling point >150° C.). Their chemical compositions, and catalytic data obtained by using with such raw pyrolysis gasolines as feeds, and over the same and previously mentioned hybrid catalyst (HYB), are reported in Tables 19 and 20, respectively. Are also reported—for comparison purpose—the catalytic results obtained with the REF (reference catalyst).

As reported in Table 19, the thermo-catalytic cracking of the pyrolysis gasoline (heavy, type B) produced gaseous products at the expense of the “heavy” liquid hydrocarbons or other liquid hydrocarbons (Δ=−63 wt %, ca), the C₅-C₉ non-aromatic (variation Δ=−52 wt %, ca, the run at 525° C. being considered), and, at a much lesser extend, the BTX aromatics (Δ=−25 wt %, ca). The BTX mono-aromatics experienced a quite significant decrease because of the effect of hydrogenation-ring opening of the hybrid catalyst [see Example 3]. Nevertheless, the liquid hydrocarbons that underwent cracking, were assumed to be primarily non-aromatic compounds. In the temperature range investigated, ethylene was produced in much larger proportions than propylene, around twice as much. The increase of the reaction temperature from 525° C. to 600° C. did not significantly change the entire product spectrum. The yield of methane was remarkably low.

It is worth noting that the TCC process applying to such a kind of raw pyrolysis gasoline, should use the lowest vaporization temperature as possible, so that to avoid an excessive “encrusting” of the catalyst surface or the formation of unwanted polymers (resins) in the feeding system, due to the presence of unstable hydrocarbons such as the diolefins. In addition to the dilution of this raw pyrolysis gasoline with steam, its dilution with heavy naphtha could also be considered.

TABLE 19
Chemical composition of PY-GAS (B) (specific gravity =
0.91 g/mL; boiling point range = 158-238° C.) and data of
catalytic tests using such raw pyrolysis gasoline.

| | | Product yields (wt %) | | | | |
|---|---|---|---|---|---|---|
| | | Catalyst | | | | |
| | | REF | HYB | | | |
| | Composition | Reaction Temp. (° C.) | | | | |
| | (PY-GAS(B)) | 525 | 525 | 550 | 575 | 600 |
| Hydrogen | | 1.4 | 1.4 | 1.4 | 1.4 | 1.3 |
| Methane | | 0.7 | 0.5 | 0.9 | 1.1 | 2.7 |
| Ethane | | 0.4 | 0.2 | 0.3 | 0.4 | 0.7 |
| Ethylene | | 27.0 | 26.5 | 27.1 | 27.6 | 25.1 |
| Propane | | 0.4 | 0.3 | 0.2 | 0.2 | 0.2 |
| Propylene | | 14.0 | 14.4 | 13.0 | 12.5 | 12.6 |
| Butanes | | 0.0 | 0.0 | 0.0 | 0.0 | 0.0 |
| Isobutene | | 1.1 | 1.0 | 2.8 | 2.7 | 2.6 |
| n-butenes | | 2.7 | 2.6 | 0.6 | 1.0 | 1.0 |
| 1,3-butadiene | | 0.6 | 0.7 | 0.3 | 0.2 | 0.4 |
| C₅-C₉ non-arom. | 2.7 | 1.3 | 1.3 | 1.8 | 1.9 | 2.6 |
| Benzene | 8.4 | 9.2 | 7.3 | 5.6 | 7.0 | 6.2 |
| Ethylbenzene | 3.1 | 4.7 | 6.1 | 7.0 | 6.6 | 7.0 |
| Toluene | 8.9 | 8.6 | 7.8 | 6.3 | 7.4 | 6.9 |
| Xylenes | 20.6 | 8.3 | 9.5 | 10.2 | 8.1 | 10.4 |
| (150-300° C.) | 55.9 | 18.7 | 19.7 | 21.7 | 22.0 | 20.4 |
| (300-400° C.) | 0.5 | 0.8 | 0.8 | 0.5 | 0.6 | 0.4 |
| (>400° C.) | 0.0 | 0.0 | 0.0 | 0.0 | 0.0 | 0.0 |
| Ethylene + | | 41.0 | 40.9 | 40.1 | 40.1 | 37.7 |
| propylene | | | | | | |
| Ethylene/propylene | | 1.9 | 1.9 | 2.1 | 2.2 | 2.0 |
| C₂-C₄ olefins | | 44.8 | 44.5 | 43.5 | 43.8 | 41.3 |
| BTX aromatics | 41.0 | 30.8 | 30.7 | 29.1 | 29.1 | 30.5 |
| Other liquid | 55.4 | 19.5 | 20.5 | 22.2 | 22.6 | 20.8 |
| products | | | | | | |

Table 20 reports the thermo-catalytic cracking of the lighter pyrolysis gasoline (light, type A). As in the case of type B-gasoline, the formation of gaseous products by TCC reaction occurred at the expense of the C₅-C₉ non-aromatic hydrocarbons (variation, Δ=−79 wt %, the run at 525° C. being considered), <<heavy>> products (Δ=−27 wt %) and BTX aromatics (Δ=−35 wt %). The conversion of BTX aromatics (particularly, of benzene) was another experimental evidence of the effect of hydrogenation-ring opening of the hybrid catalyst. In contrast with the heavier gasoline, the lighter gasoline produced more propylene than ethylene (ethylene/propylene ratio lower than 1.0, i.e. propylene being produced in much larger yield than ethylene, more than twice as much).

Because the presence of less convertible BTX aromatics was more important in gasoline (A) than in gasoline B, the amounts of gaseous products, and thus of ethylene+propylene, obtained with gasoline A were significantly lower. The increase of the reaction temperature from 525° C. to 600° C. did not significantly change the entire product spectrum. The yield of methane was remarkably low.

It is worth noting that
all these catalytic results were obtained at reaction temperatures much lower than those used for the TCC process with naphthas and gas oils (725° C.) [see Example 3].
the reference catalyst (REF) in which the co-catalyst was the undoped yttria-stabilized aluminum oxide (AAS), showed almost the same performance as the hybrid catalyst (HYB). This suggests that the stabilizing role of the co-catalyst (owing to the hydrogen spilt-over species) is much less important than in the TCC process, the latter being carried out at much higher temperature (725° C.) [see Example 3].

TABLE 20
Chemical composition of PY-GAS (A) (specific gravity =
0.84 g/mL, boiling point range = 85-170° C.) and data of
catalytic tests using such raw pyrolysis gasoline.

| | | Product yields (wt %) | | | | |
|---|---|---|---|---|---|---|
| | | CATALYST | | | | |
| | | REF | HYB | | | |
| | Composition | Reaction Temp. (° C.) | | | | |
| | (PY-GAS(A)) | 525 | 525 | 550 | 575 | 600 |
| Hydrogen | | 1.2 | 1.2 | 1.1 | 1.1 | 1.1 |
| Methane | | 0.6 | 0.3 | 0.5 | 0.9 | 1.7 |
| Ethane | | 0.5 | 0.3 | 0.2 | 0.4 | 0.4 |
| Ethylene | | 16.2 | 14.8 | 14.9 | 15.0 | 15.3 |
| Propane | | 0.8 | 0.6 | 0.3 | 0.3 | 0.3 |
| Propylene | | 18.3 | 19.7 | 17.7 | 18.6 | 17.9 |
| Butanes | | 0.0 | 0.0 | 0.0 | 0.0 | 0.0 |
| Isobutene | | 1.1 | 2.2 | 4.4 | 3.2 | 4.5 |
| n-butenes | | 3.7 | 3.1 | 3.1 | 4.4 | 3.4 |
| 1,3-butadiene | | 2.3 | 2.0 | 0.2 | 0.3 | 0.4 |
| C₅-C₉ non-arom. | 22.1 | 1.9 | 4.7 | 8.0 | 9.2 | 9.5 |
| Benzene | 46.7 | 26.5 | 25.7 | 26.1 | 24.6 | 25.2 |
| Ethylbenzene | 1.7 | 3.8 | 4.1 | 4.1 | 3.6 | 3.1 |
| Toluene | 15.7 | 11.8 | 11.3 | 11.2 | 10.6 | 10.4 |
| Xylenes | 5.5 | 4.3 | 4.3 | 4.0 | 3.4 | 3.2 |
| (150-300° C.) | 8.1 | 5.0 | 5.5 | 5.3 | 4.5 | 3.5 |
| (300-400° C.) | 0.1 | 0.3 | 0.4 | 0.2 | 0.0 | 0.1 |
| (>400° C.) | 0.0 | 0.0 | 0.0 | 0.0 | 0.0 | 0.0 |
| Ethylene + | | 34.5 | 34.5 | 32.6 | 33.6 | 33.2 |
| propylene | | | | | | |
| Ethylene/propylene | | 0.89 | 0.75 | 0.84 | 0.81 | 0.86 |
| C₂-C₄ olefins | | 39.3 | 39.8 | 40.1 | 41.2 | 41.1 |
| BTX aromatics | 69.9 | 46.4 | 45.4 | 45.4 | 42.2 | 41.9 |
| Other liquid | 8.1 | 5.3 | 5.9 | 5.5 | 4.5 | 3.6 |
| products | | | | | | |

Catalytic Results Obtained with Various Blends of “Raw Pyrolysis Gasoline B with Heavy Naphtha” (at Lower Reaction Temperatures).

Four mixtures of heavy naphtha with PY-GAS B (MIX-1, MIX-2, MIX-3 and MIX-4) were prepared. They contained 15, 25, 40 and 75 wt % of heavy naphtha, respectively (balance=PY-GAS B).

First of all, in comparison with the PY-GAS B, the heavy naphtha used in these mixtures, was much richer in non-aromatic liquid hydrocarbons and poorer in BTX aromatics. It did not contain any compound heavier than 300° C. (boiling point).

As shown in Table 21, dilution of the PY-GAS B with such naphtha gradually decreased the yield in light olefins (and in particular, ethylene+propylene), due mainly to the sharply decreasing ethylene yield. The yield in BTX aromatics decreased with increasing dilution, owing to lower concentrations of the BTX in the feed mixtures. A dilution of 15 wt % with heavy naphtha (MIX-1), did not change much the product spectrum (except for a higher production of propylene, Table 21 vs. Table 19). Note that the presence of the naphtha, even at a low concentration, helped avoid the formation of resins (produced from diolefinic species of the PY-GAS B) in the reactant feeding section.

TABLE 21
Catalytic data obtained with various mixtures of PY-GAS
B/heavy naphtha (H.N.) over the HYB catalyst (product yields, wt %).
T = 525° C., other reaction parameters = see experimental section.

| Feed (H.N., wt %) | MIX-1 (15) | MIX-2 (25) | MIX-3 (40) | Mix-4 (75) | H.N. |
|---|---|---|---|---|---|
| Density (g/mL) | 0.88 | 0.85 | 0.82 | 0.77 | 0.75 |
| Hydrogen | 1.3 | 1.2 | 1.1 | 1.0 | 0.9 |
| Methane | 0.5 | 0.6 | 0.7 | 0.6 | 0.7 |
| Ethane | 0.7 | 0.7 | 0.8 | 1.5 | 1.7 |
| Ethylene | 22.2 | 20.3 | 17.7 | 9.3 | 6.7 |
| Propane | 1.1 | 1.0 | 1.1 | 3.6 | 4.2 |
| Propylene | 17.5 | 15.2 | 15.0 | 20.0 | 22.0 |
| Butanes | 0.7 | 0.6 | 0.6 | 0.7 | 0.6 |
| Isobutene | 1.2 | 0.7 | 4.3 | 6.2 | 6.9 |
| n-butenes | 3.6 | 3.3 | 0.7 | 2.2 | 2.0 |
| 1,3-butadiene | 0.9 | 0.8 | 0.8 | 0.0 | 0.0 |
| C₅-C₉ non-arom. | 7.4 | 12.6 | 20.1 | 31.9 | 42.4 |
| Benzene | 7.5 | 6.4 | 5.8 | 5.3 | 3.1 |
| Ethylbenzene | 4.7 | 5.7 | 5.0 | 2.5 | 1.3 |
| Toluene | 7.4 | 7.1 | 6.7 | 6.4 | 4.4 |
| Xylenes | 7.6 | 8.5 | 7.4 | 4.8 | 2.6 |
| (150-300° C.) | 15.3 | 15.2 | 12.1 | 4.1 | 0.7 |
| (300-400° C.) | 0.6 | 0.5 | 0.2 | 0.1 | 0.0 |
| (>400° C.) | 0.0 | 0.0 | 0.0 | 0.0 | 0.0 |
| Ethylene + propylene | 39.7 | 35.5 | 32.7 | 29.3 | 28.7 |
| Ethylene/propylene | 1.27 | 1.34 | 1.18 | 0.47 | 0.31 |
| C₂-C₄ olefins | 44.5 | 39.5 | 37.7 | 37.7 | 37.6 |
| BTX aromatics | 27.2 | 27.7 | 24.9 | 19.0 | 11.4 |
| Other liquid products | 15.9 | 15.7 | 12.3 | 4.2 | 0.7 |

Catalytic Results Obtained with Heavy Naphtha and its Various Blends with Raw Pyrolysis Gasoline B (at Higher Reaction Temperatures).

As reported in Table 22, the blends of heavy naphtha with the raw pyrolysis gasoline (PY-GAS B) (up to 30 wt % and more) resulted in slightly lower combined yields in ethylene and propylene than obtained with the heavy naphtha alone (Table 18). However, the yield in BTX aromatics was significantly higher because of the higher content of these aromatics in the PY-GAS B.

It is worth noting that the conversion of mixtures of PY-GAS B (main component) with heavy naphtha (minor component, up to 30 wt %) showed an ethylene/propylene product ratio higher 1.0 (i.e. more ethylene produced than propylene, Table 21). On the other hand, the use of mixtures of heavy naphtha (main component) with PY-GAS B (minor component, up to 30 wt %) resulted in an ethylene/propylene product ratio lower than 1.0 (i.e. more propylene produced than ethylene, Table 22). To achieve almost the same combined (ethylene+propylene) yield, a significantly higher reaction temperature had to be used for the mixtures of heavy naphtha with PY-GAS B.

Such flexibility in the production of ethylene and propylene represents an enormous advantage for the industry because the only reaction parameters to change are the concentration of the mixture components and the reaction temperature.

TABLE 22
Catalytic data obtained with the various mixtures of heavy
naphtha (H.N.) with PY-GAS B (product yields, wt %).

| Feed (PY-GAS B, wt %) | MIX-1 (10) | MIX-2 (20) | MIX-3 (30) |
|---|---|---|---|
| Hydrogen | 1.5 | 1.4 | 1.3 |
| Methane | 4.8 | 4.6 | 4.8 |
| Ethane | 3.2 | 2.9 | 2.9 |
| Ethylene | 17.4 | 16.5 | 15.8 |
| Propane | 2.7 | 2.1 | 2.2 |
| Propylene | 27.0 | 25.9 | 23.2 |
| Butanes | 1.1 | 0.7 | 1.2 |
| Isobutene | 8.5 | 8.0 | 6.3 |
| n-butenes | 2.6 | 3.0 | 3.0 |
| 1,3-butadiene | 0.6 | 0.6 | 0.4 |
| C₅—C₉ non-arom. | 14.0 | 13.4 | 12.7 |
| Benzene | 4.7 | 5.6 | 7.0 |
| Ethylbenzene | 0.5 | 0.7 | 0.9 |
| Toluene | 6.2 | 6.2 | 7.4 |
| Xylenes | 3.7 | 4.6 | 5.3 |
| (150-300° C.) | 2.1 | 3.8 | 5.6 |
| (300-400° C.) | 0.0 | 0.0 | 0.1 |
| (>400° C.) | 0.0 | 0.0 | 0.0 |
| Ethylene + propylene | 44.4 | 42.4 | 39.0 |
| Ethylene/propylene | 0.64 | 0.64 | 0.68 |
| C₂—C₄ olefins | 55.5 | 53.4 | 48.3 |
| BTX aromatics | 15.1 | 17.1 | 20.6 |
| Other liquid products | 2.1 | 3.8 | 5.7 |

T = 675° C., other reaction
parameters = see experimental section.

Catalytic Results Obtained with Heavy Haphtha and its Various Blends with Fuel Oil (Product of Steam-Cracking).

The pyrolysis fuel oil used, kindly provided by Petromont Inc. (Canada), was a heavy oil (density=1.06 g/mL) which contained diolefinic and alkenyl aromatic species. Thus, its tendency to produce resins is very high. However, blends of heavy naphtha with such pyrolysis fuel oil (up to 20 wt %) could be used to produce light olefins, without any problem excepted that some precaution (temperature not to high) had to be taken during the vaporization phase. The differences between the product spectrum of pure heavy naphtha (Table 18) and those of these mixtures (Table 23) were more pronounced than those with the PY-GAS B (Table 22), because pyrolysis fuel oil, being heavier that the raw pyrolysis gasoline, led to more important catalyst activity decay. Therefore, the recommended percentage of the pyrolysis fuel oil blended with heavy naphtha is much lower. Note that the TCC conversion of this fuel oil can be done in normal conditions of the TCC process [R. Le Van Mao, N. T. Vu, N. Al-Yassir, N. François, J. Monnier, Top. Catal., 37 (2006), 107 and Example 3].

TABLE 23
Catalytic data obtained with various mixtures of heavy
naphtha (H.N.) with pyrolysis fuel oil over the HYB catalyst
(product yields, wt %).

| Feed (fuel oil, wt %) | MIX 1 (10) | MIX (15) | MIX (20) |
|---|---|---|---|
| Hydrogen | 1.4 | 1.4 | 1.4 |
| Methane | 5.4 | 5.2 | 5.2 |
| Ethane | 2.9 | 3.0 | 3.1 |
| Ethylene | 16.0 | 15.4 | 15.5 |
| Propane | 2.4 | 1.8 | 2.0 |
| Propylene | 25.7 | 25.7 | 25.3 |
| Butanes | 0.5 | 0.8 | 0.3 |
| Isobutene | 8.1 | 8.8 | 8.5 |
| n-butenes | 2.8 | 3.6 | 2.7 |
| 1,3-butadiene | 0.7 | 0.7 | 0.7 |
| C₅—C₉ non-arom. | 14.0 | 17.3 | 17.9 |
| Benzene | 4.1 | 3.7 | 3.8 |
| Ethylbenzene | 0.7 | 0.6 | 0.7 |
| Toluene | 5.9 | 4.8 | 5.4 |
| Xylenes | 3.4 | 3.0 | 3.2 |
| (150-300° C.) | 2.6 | 3.4 | 3.6 |
| (300-400° C.) | 0.6 | 1.0 | 1.0 |
| (>400° C.) | 0.0 | 0.0 | 0.0 |
| Ethylene + propylene | 41.7 | 41.1 | 40.8 |
| Ethylene/propylene | 0.62 | 0.60 | 0.61 |
| C₂—C₄ olefins | 52.6 | 53.5 | 52.0 |
| BTX aromatics | 14.1 | 12.1 | 13.1 |
| Other liquid products | 3.2 | 4.4 | 4.6 |

T = 675° C.,
other reaction parameters = see experimental section.

Results of Catalytic Tests with Linear (Long-Chain) Olefins.

Linear olefins are interesting feedstocks for the TCC catalysts. Essentially, over acidic catalysts, alpha-olefins undergo first isomerization to beta- or gamma-olefins before being cracked in shorter olefins. This multi-step reaction mechanism allows the production of light olefins from 1-tetradecene, 1-hexadecene or 1-octadecene used as model molecules for long-chain (linear) alpha-olefins. Several mixtures of these linear alpha-olefins were also tested over our TCC hybrid catalysts.

As shown in Table 24, the TCC reaction with various linear alpha olefins resulted in high yields of light olefins (more than 80 wt %), particularly ethylene and propylene (more than 60 wt %). Propylene was produced in much higher yield than ethylene. Some BTX aromatics were also obtained. No liquid products with boiling point higher than 300° C. were obtained.

With a mixture of alpha-olefins whose molecules contained 10 C to 18 C, the combined yield of light olefins was higher than 80 wt % (Table 25), and that of ethylene+propylene, higher than 60 wt %. Again, propylene was produced in very large proportions, with a propylene/ethylene ratio being much higher than 2. Some BTX aromatics were also obtained.

It is worth noting that all these catalytic results were obtained at reaction temperatures much lower than those used for the TCC process with naphthas and gas oils [see Example 3].

TABLE 24
Catalytic results obtained with various alpha-olefinic feeds
over the hybrid catalyst, HYB
(Reaction temperature = 630° C.).

| Feed | 1-tetradecene | 1-hexadecene | 1-octadecene |
|---|---|---|---|
| Product yield (wt %) | | | |
| Hydrogen | 2.1 | 2.1 | 2.1 |
| Methane | 1.3 | 1.2 | 1.1 |
| Ethane | 0.6 | 0.7 | 0.5 |
| Ethylene | 19.1 | 18.3 | 16.5 |
| Propane | 2.3 | 2.3 | 1.7 |
| Propylene | 44.8 | 45.1 | 47.5 |
| Butanes | 0.3 | 0.3 | 0.2 |
| Isobutene | 2.7 | 0.9 | 0.0 |
| n-butenes | 14.4 | 16.2 | 19.7 |
| 1,3-butadiene | 0.4 | 0.4 | 0.5 |
| C₅—C₉ non-arom. | 7.9 | 7.5 | 7.1 |
| Benzene | 0.8 | 0.9 | 0.7 |
| Ethylbenzene | 0.3 | 0.4 | 0.3 |
| Toluene | 2.0 | 2.2 | 1.4 |
| Xylenes | 0.9 | 1.1 | 0.7 |
| (150-300° C.) | 0.4 | 0.5 | 0.3 |
| (300-400° C.) | 0.0 | 0.0 | 0.0 |
| (>400° C.) | 0.0 | 0.0 | 0.0 |
| Ethylene + propylene | 63.9 | 63.4 | 64.0 |
| Ethylene/propylene | 0.43 | 0.41 | 0.35 |
| C₂—C₄ olefins | 81.0 | 80.5 | 83.7 |
| BTX aromatics | 4.0 | 4.6 | 3.1 |
| Other liquid products | 0.4 | 0.5 | 0.3 |

TABLE 25
Catalytic results (product yield, wt %) obtained with a
mixture of alpha-olefins of the following composition (wt %): 1-decene,
38.9; 1-dodecene, 26.2; 1-tetradecene, 17.0; 1-hexadecene,
11.0; 1-octadecene = 6.9. Reaction temperature = 615° C.

| | Run number* | | | | |
|---|---|---|---|---|---|
| | 1 | 2 | 3 | 4 | 5 |
| Hydrogen | 2.0 | 2.1 | 2.1 | 2.1 | 2.1 |
| Methane | 0.9 | 1.0 | 0.8 | 1.0 | 1.0 |
| Ethane | 0.5 | 0.6 | 0.6 | 0.7 | 0.7 |
| Ethylene | 15.7 | 19.1 | 18.5 | 20.0 | 19.8 |
| Propane | 2.0 | 2.7 | 2.8 | 3.2 | 3.3 |
| Propylene | 44.1 | 46.8 | 43.2 | 44.0 | 43.7 |
| Butanes | 0.3 | 0.3 | 0.4 | 0.4 | 0.4 |
| Isobutene | 2.0 | 1.7 | 1.8 | 1.3 | 1.8 |
| n-butenes | 19.7 | 13.1 | 17.4 | 14.9 | 15.3 |
| 1,3-butadiene | 0.3 | 0.3 | 0.3 | 0.3 | 0.3 |
| C₅-C₈ non- | 8.3 | 7.6 | 7.2 | 6.7 | 6.6 |
| aromatics | | | | | |
| Benzene | 0.9 | 0.9 | 0.8 | 0.8 | 0.8 |
| Ethylbenzene | 0.4 | 0.3 | 0.4 | 0.4 | 0.4 |
| Toluene | 1.7 | 2.0 | 2.3 | 2.6 | 2.5 |
| Xylenes | 1.2 | 1.1 | 1.1 | 1.4 | 1.3 |
| (150-300° C.) | 0.6 | 0.5 | 0.5 | 0.5 | 0.5 |
| (300-400° C.) | 0.0 | 0.0 | 0.0 | 0.0 | 0.0 |
| (>400° C.) | 0.0 | 0.0 | 0.0 | 0.0 | 0.0 |
| Ethylene + | 59.8 | 65.9 | 61.7 | 64.0 | 63.5 |
| propylene | | | | | |
| Ethylene/ | 0.36 | 0.41 | 0.43 | 0.46 | 0.45 |
| propylene | | | | | |
| C₂-C₄ olefins | 81.5 | 80.7 | 80.9 | 80.2 | 80.6 |
| BTX aromatics | 4.2 | 4.3 | 4.6 | 5.2 | 5.0 |
| Other liquid | 0.6 | 0.5 | 0.5 | 0.5 | 0.5 |
| products | | | | | |

*runs of 5 h with no interruption of the reactor heating for 5 days.

Although the present invention has been described hereinabove by way of specific embodiments thereof, it can be modified, without departing from the spirit and nature of the subject invention as defined in the appended claims.

1. A co-catalyst comprising yttria-stabilized aluminum oxide having nickel oxide loaded thereon.

2. The co-catalyst of claim 1 comprising between about 0.5 and about 6 wt % of nickel in the form of said nickel oxide.

3. (canceled)

4. The co-catalyst of claim 1 further comprising cerium oxide, rhenium oxide, ruthenium oxide, tin oxide or mixtures thereof.

5. The co-catalyst of claim 4 comprising between about 0.5 and about 4 wt % of cerium oxide; up to about 1.5 wt % of rhenium oxide, up to about 4 wt % of tin oxide, and up to about 0.5 wt % of ruthenium oxide.

6-12. (canceled)

13. A hybrid catalyst comprising the co-catalyst of claim 1 and a main catalyst component.

14. The hybrid catalyst of claim 13 comprising between about 10 and about 25 wt % of said co-catalyst.

15. The hybrid catalyst of claim 13 wherein said main catalyst component comprises yttria-stabilized aluminium oxide having loaded thereon:
(a) molybdenum oxide, tungsten oxide or mixtures thereof;
(b) cerium oxide, lanthanum oxide or mixture thereof; and
(c) phosphorus, chloride or mixtures thereof.

16. The hybrid catalyst of claim 13 wherein said main catalyst component comprises yttria-stabilized aluminium oxide, yttria-stabilized zirconium oxide or mixtures thereof, said yttria-stabilized aluminium oxide, yttria-stabilized zirconium oxide or mixtures thereof having loaded thereon:
(a) molybdenum oxide, tungsten oxide or mixtures thereof;
(b) cerium oxide, lanthanum oxide or mixture thereof; and
(c) phosphorus, sulfur, chloride or mixtures thereof.

17. The hybrid catalyst of claim 13 wherein said main catalyst component comprises an acidic ZSM-5 zeolite having loaded thereon:
(a) molybdenum oxide, tungsten oxide or mixtures thereof;
(b) yttrium oxide, cerium oxide, lanthanum oxide or mixtures thereof; and
(c) phosphorus, chloride or mixtures thereof.

18-28. (canceled)

29. The hybrid catalyst of claim 13 wherein said main catalyst component further comprises nickel oxide loaded thereon.

30. The hybrid catalyst of claim 29 wherein said main catalyst component comprises up to about 5 wt % of nickel in the form of said nickel oxide.

31-39. (canceled)

40. A thermo-catalylic cracking monocomponent catalyst having nickel oxide loaded thereon.

41. The catalyst of claim 40 comprising up to about 3 wt % of nickel in the form of said nickel oxide.

42-43. (canceled)

44. A monocomponent catalyst comprising yttria-stabilized aluminum oxide having loaded thereon:
(a) nickel oxide;
(b) one of molybdenum oxide, tungsten oxide or mixtures thereof;
(c) one of cerium oxide, lanthanum oxide or mixture thereof; and
(d) one of phosphorus, chloride or mixtures thereof.

45. (canceled)

46. A monocomponent catalyst comprising an acidic ZSM-5 zeolite having loaded thereon:
(a) nickel oxide;
(b) one of molybdenum oxide, tungsten oxide or mixtures thereof;
(c) one of yttrium oxide, cerium oxide, lanthanum oxide or mixtures thereof; and
(d) one of phosphorus, chloride or mixtures thereof.

47. (canceled)

48. The catalyst of claim 44 comprising up to about 3 wt % of nickel in the form of said nickel oxide.

49-105. (canceled)

106. The catalyst of claim 46 comprising up to about 3 wt % of nickel in the form of said nickel oxide.
